(19) United States
(12) Patent Application Publication
(10) Pub. No.: US 2006/0128939 A1
(43) Pub. Date: Jun. 15, 2006

(54) One pot process for making polymeric antioxidants

(76) Inventors: Vijayendra Kumar, Dracut, MA (US); Suizhou Yang, Lowell, MA (US); Ashok L. Cholli, Chelmsford, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/293,049

(22) Filed: Dec. 2, 2005

Related U.S. Application Data
(60) Provisional application No. 60/633,252, filed on Dec. 3, 2004.

(51) Int. Cl. C08G 75/00

(52) U.S. Cl. 528/373

(57) ABSTRACT

Disclosed is a method for the synthesis of sterically hindered polymeric antioxidants based on phenol type antioxidant monomers. The method includes mono-deacetylating, polymerizing and deacetylating an aryl monomer represented by the following structural formula: 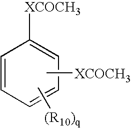
to produce a sterically hindered polymeric macromolecular antioxidant. X, R₁₀ and q are as defined herein. The disclosed method is a simple, direct and economical process for the synthesis of sterically hindered polymeric macromolecular antioxidants.

### RELATED APPLICATION(S)

This application claims the benefit of U.S. Provisional Application No. 60/633,252, filed on Dec. 3, 2004. The entire teachings of the above application are incorporated herein by reference.

### BACKGROUND OF THE INVENTION

Many polymeric antioxidants possess significantly higher antioxidant activities compared to corresponding small molecule antioxidants, along with improved thermal stability and performance in a wide range of materials, for example, plastics, elastomers, lubricants, petroleum based products (lubricants, gasoline, aviation fuels, and engine oils), cooking oil, cosmetics, processed food products, and the like.

The synthesis of polymeric phenol antioxidants (including sterically hindered polymeric phenol antioxidants) from substituted phenols, using a hydroxyl group protection/deprotection approach is described in patent applications to Cholli, et al., including U.S. Provisional Application No. 60/370,468, U.S. Patent Application Publication No. 2003/230743, International Patent Publication No.s: WO 2003/87260, and WO 2005/071005, and U.S. patent application Ser. No. 10/408,679 the entire teachings of each of which are incorporated herein by reference. These methods require multiple steps and purification of intermediates at each step. For example, WO 2003/87260 discloses a synthesis of poly (tert-butylhydroquinone) (poly(TBHQ)) that requires four separate steps, including separation of intermediate components at each step.

### SUMMARY OF THE INVENTION

Disclosed is a one pot method of synthesizing (sterically hindered phenol) antioxidants. The method employs a hydroxyl group (or an amino group or a thio group) protection/deprotection approach and occurs in a one pot process.

The methods of the present invention include a first step of mono-deacetylating an aryl monomer represented by the following structural formula: 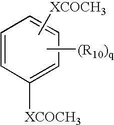
At least one ring carbon atom substituted with an XCOCH₃ group is adjacent to a ring carbon atom substituted with a C1-C10 alkyl group or an optionally substituted aryl group. Each X is independently —O—, —NH— or —S—. Each R₁₀ is independently an optionally substituted C1-C10 alkyl group, an optionally substituted aryl group, and optionally substituted alkoxy group, an optionally substituted carbonyl group, an optionally substituted alkoxycarbonyl group, an optionally substituted aryloxycarbonyl group, —OH, —SH or —NH₂; and/or two R₁₀ groups on adjacent carbon atoms join together to form an optionally substituted aromatic ring or an optionally substituted carbocyclic or heterocyclic non-aromatic ring. q is an integer from 0 to 2. The mono-deacetylation is carried out in the presence of a deacetylating catalyst to produce a monoacetylated aryl monomer represented by the following structural formula:

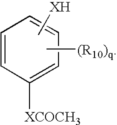

The methods of the present invention further include a second step of polymerizing the monoacetylated aryl monomer, to form a polymer comprising at least one repeat unit selected from: 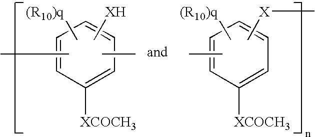
n is an integer greater than or equal to 2.

The methods of the present invention further include a third step of contacting the polymer with an acid to produce a deacetylated antioxidant polymer comprising at least one repeat unit selected from:

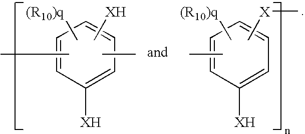

In another embodiment, the present invention is a method of synthesizing an antioxidant polymer, comprising the steps of mono-deprotecting an aryl monomer represented by the following structural formula:

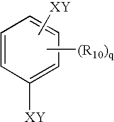

At least one ring carbon atom substituted with an XY group is adjacent to a ring carbon atom substituted with an optionally substituted C1-C10 alkyl group or an optionally substituted aryl group. Each X is independently —O—, —NH— or —S—. Each Y is benzyl, benzoyl, tetrahydropyranyl, carbonate, acetal, ketal, tretyl, dimethoxytretyl, trimethoxytretyl or silyl. Each R₁₀ is independently an optionally substituted C1-C10 alkyl group, an optionally substituted aryl group, and optionally substituted alkoxy group, an optionally substituted carbonyl group, an optionally substituted alkoxycarbonyl group, an optionally substituted aryloxycarbonyl group, —OH, —SH or —NH₂; and/or two R₁₀ groups on adjacent carbon atoms join together to form an optionally substituted aromatic ring or an optionally substituted carbocyclic or heterocyclic non-aromatic ring. q is an integer from 1 to 2.

The mono-deprotection creates a deprotected aryl monomer represented by the following structural formula:

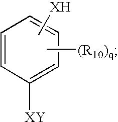

The method further includes a second step of polymerizing the deprotected aryl monomer, to form a polymer comprising at least one repeat unit selected from: 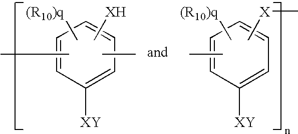
n is an integer greater than or equal to 2.

The method further includes a third step of deprotecting the polymer to form an antioxidant polymer comprising at least one repeat unit selected from:

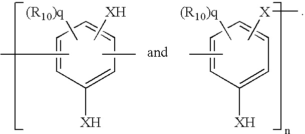

The invention provides an economical, one pot process for preparing these antioxidant polymers that is largely environmentally-safe. The present invention demonstrates the synthesis, by one pot process involving the same protection and deprotection scheme as described in U.S. Patent Application Publication No.: 2003/230743. The present invention describes a simple, direct and economical process for the synthesis of polymeric antioxidants. The methods of the invention allow for the cost effective synthesis of polymeric antioxidants. Polymeric antioxidants made by the methods of the present invention in general possess significantly higher antioxidant activities along with improved thermal stability and performance in a wide range of materials including but not limited to plastics, elastomers, lubricants, petroleum based products (lubricants, gasoline, aviation fuels, and engine oils), cooking oil, cosmetics, processed food products.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIGS. 1A and 1B are high resolution 500 MHz ¹H nuclear magnetic resonance (NMR) spectra of monomeric tert-butyl hydroquinone (TBHQ) of the invention (FIG. 1A) and monomeric TBHQ diacetate of the invention (FIG. 1B). In the ¹H NMR spectrum of diacetate (1B), the appearance of peaks at 2.2 and 2.3 ppm is evidence for the formation of diacetate.

FIG. 2 is a high resolution 500 MHz ¹H NMR spectra of Poly(TBHQ) of the invention. The disappearance of peaks at 2.2 and 2.3 ppm in the ¹H NMR spectrum of poly (TBHQ) in compared to FIG. 1B are evidence for the removal of the acetyl group from the polymerized material.

FIG. 3 is a graph of the oxidative induction time of poly(TBHQ) of the invention made by the methods described in Example 2 in polypropylene.

FIG. 4 is a graph of the oxidative induction time of poly(TBHQ) made by the methods described in Example 2 in Groupp II (LV) base oil.

### DETAILED DESCRIPTION OF THE INVENTION

A description of preferred embodiments of the invention follows.

The present invention is generally directed to methods of synthesizing sterically hindered phenol derived antioxidant polymers (polyalkylphenol antioxidants).

Sterically hindered, as used herein means that the substituent group (e.g., bulky alkyl group) on a ring carbon atom adjacent (or para) to a ring carbon atom substituted with a phenolic hydroxy group (or thiol or amine group), is large enough to sterically hinder the phenolic hydroxy group (or thiol or amine groups). This steric hinderance, in certain embodiments results in more labile or weak bonding between the oxygen and the hydrogen (or sulfur or nitrogen and hydrogen) and in turn enhances the stability and antioxidant activity (proton donating activity) of the sterically hindered antioxidant.

Such antioxidant polymers can be employed to inhibit the oxidation of an oxidizable material, for example by contacting the material with an antioxidant polymer made by the methods of the present invention.

For purposes of the present invention, a method of “inhibiting oxidation” is a method that inhibits the propagation of a free radical-mediated process. Free radicals can be generated by heat, light, ionizing radiation, metal ions and some proteins and enzymes. Inhibiting oxidation also includes inhibiting reactions caused by the presence of oxygen, ozone or another compound capable of generating these gases or reactive equivalents of these gases.

As used herein the term “oxidizable material“ is any material which is subject to oxidation by free-radicals or oxidative reaction caused by the presence of oxygen, ozone or another compound capable of generating these gases or reactive equivalents thereof. In particular the oxidizable material is a lubricant or a mixture of lubricants.

Repeat units of the antioxidant polymers of the invention include substituted benzene molecules. These benzene molecules are typically based on phenol or a phenol derivative, such that they have at least one hydroxyl or ether functional group. In certain embodiments, the benzene molecules have a hydroxyl group. The hydroxyl group can be a free hydroxyl group and can be protected or have a cleavable group attached to it (e.g., an ester group). Such cleavable groups can be released under certain conditions (e.g., changes in pH), with a desired shelf life or with a time-controlled release (e.g., measured by the half-life), which allows one to control where and/or when an antioxidant polymer can exert its antioxidant effect. The repeat units can also include analogous thiophenol and aniline derivatives, e.g., where the phenol —OH can be replaced by —SH, —NH—, and the like.

Substituted benzene repeat units of an antioxidant polymer of the invention are also typically substituted with a bulky alkyl group or an n-alkoxycarbonyl group. In certain embodiments, the benzene monomers are substituted with a bulky alkyl group. In certain other embodiments, the bulky alkyl group is located ortho or meta to a hydroxyl group on the benzene ring, typically ortho. A “bulky alkyl group” is defined herein as an alkyl group that is branched alpha- or beta- to the benzene ring. In certain other embodiments, the alkyl group is branched alpha to the benzene ring. In certain other embodiments, the alkyl group is branched twice alpha to the benzene ring, such as in a tert-butyl group. Other examples of bulky alkyl groups include isopropyl, 2-butyl, 3-pentyl, 1,1-dimethylpropyl, 1-ethyl-1-methylpropyl and 1,1-diethylpropyl. In certain other embodiments, the bulky alkyl groups are unsubstituted, but they can be substituted with a functional group that does not interfere with the antioxidant activity of the molecule or the polymer. Straight chained alkoxylcarbonyl groups include methoxycarbonyl, ethoxycarbonyl, n-propoxycarbonyl, n-butoxycarbonyl and n-pentoxycarbonyl. N-propoxycarbonyl is a preferred group. Similar to the bulky alkyl groups, n-alkoxycarbonyl groups are optionally substituted with a functional group that does not interfere with the antioxidant activity of the molecule or the polymer.

In certain embodiment the methods of the present invention include a first step of mono-deacetylating an aryl monomer represented by the following structural formula: 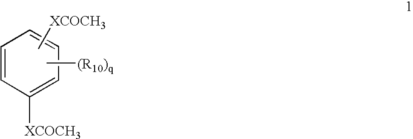
Wherein at least one ring carbon atom substituted with an XCOCH₃ group is adjacent (or ortho) to a ring carbon atom substituted with an R₁₀ group, wherein the R₁₀ group is an optionally substituted C1-C10 alkyl group or an optionally substituted aryl group. In certain embodiments, for the monomers and polymers described herein there is at least one ring carbon atom substituted with an XCOCH₃ group which is adjacent to a ring carbon atom substituted with an R₁₀ group, wherein the R₁₀ group is an optionally substituted C1-C10 alkyl group, an optionally substituted aryl group, an optionally substituted aryloxy group, and optionally substituted alkoxy group, an optionally substituted carbonyl group or an optionally substituted alkoxycarbonyl group. In certain embodiments the R₁₀ is a tert-butyl group, a benzyl group or a benzoyl group. In certain embodiments the R₁₀ is a tert-butyl group.

In certain embodiment, at least one ring carbon atom substituted with an XCOCH₃ group is meta orpara to a ring carbon atom substituted with an R₁₀ group, wherein the R₁₀ group is as described in the immediately preceding paragraph.

Each X is independently —O—, —NH— or —S—. Each R₁₀ is independently an optionally substituted C1-C10 alkyl group, an optionally substituted aryl group, and optionally substituted alkoxy group, an optionally substituted carbonyl group, an optionally substituted alkoxycarbonyl group, an optionally substituted aryloxycarbonyl group, —OH, —SH or —NH₂; and/or two R₁₀ groups on adjacent carbon atoms join together to form an optionally substituted aromatic ring or an optionally substituted carbocyclic or heterocyclic non-aromatic ring. Additionally, when two R₁₀ groups on adjacent carbon atoms join together to form an optionally substituted aromatic ring or an optionally substituted carbocyclic or heterocyclic non-aromatic ring, the optionally substituted aromatic ring or an optionally substituted carbocyclic or heterocyclic non-aromatic ring may be further fused to another (i.e., a third) optionally substituted aromatic ring or an optionally substituted carbocyclic or heterocyclic non-aromatic ring. Preferably, at least one tert-butyl group is adjacent to one XCOCH₃ group. Optionally at least one R₁₀ is tert-butyl, or an optionally substituted alkoxycarbonyl group, and q is 1; or at least one R₁₀ is tert-butyl, or optionally substituted alkoxycarbonyl group, and at least one R₁₀ is —OH, optionally substituted alkoxy, optionally substituted alkoxycarbonyl or optionally substituted aryloxycarbonyl.

In certain embodiments, each R₁₀ is independently C1-C10 alkyl group, —OH, —SH or —NH₂, or two R₁₀ groups on adjacent carbon atoms join together to form an optionally substituted aromatic ring or an optionally substituted carbocyclic or heterocyclic non-aromatic ring. In certain other embodiments, two R₁₀ groups on adjacent carbon atoms join together to form an optionally substituted non-aromatic heterocyclic ring. In certain embodiments the optionally substituted non-aromatic heterocyclic groups is optionally substituted tetrahydropyranyl or optionally substituted dihydropyranyl. In certain other embodiments the non-aromatic heterocyclic ring is optionally substituted with one or more substituents selected from the group ═O, —OH, C1-C4 alkyl, optionally substituted aryl, —OC(O)(C1-C4 alkyl), —OC(O)(aryl), —OC(O)(substituted aryl), —OC(O)(aralkyl), and —OC(O)(substituted aralkyl).

In certain embodiment the methods of the present invention include a first step of mono-deacetylating an aryl monomer represented by the following structural formula:

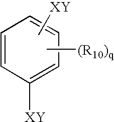

X, R₁₀, and q are as defined above. R₁₂ is a optionally substituted alkyl group, an optionally substituted aryl group, an optionally substituted aryloxy group, and optionally substituted alkoxy group, an optionally substituted carbonyl group or an optionally substituted alkoxycarbonyl group. In certain embodiments R₁₂ is a tert-butyl group, a benzyl group or a benzoyl group. In certain embodiments R₁₂ is a tert-butyl group.

In certain embodiments, in the above structures and in the compounds and monomers used and synthesized in the methods of the present invention, the —COCH₃ group act as a protecting group. In certain embodiments the protecting group is benzyl, benzoyl, THP, carbonate, acetal, ketal, tretyl, dimethoxytretyl, trimethoxytretyl, silyl, etc. The protecting group can be removed, as described above or by any method well known in the art for removing protecting groups.

In certain embodiment the present invention is method of synthesizing an antioxidant polymer, comprising the steps of mono-deprotecting an aryl monomer represented by the following structural formula:

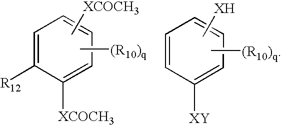

Each Y is benzyl, benzoyl, tetrahydropyranyl, carbonate, acetal, ketal, tretyl, dimethoxytretyl, trimethoxytretyl or silyl. The remainder of the variables, preferred variables and descriptions are as described above for aryl monomers.

The deprotection step creates a deprotected aryl monomer represented by the following structural formula:

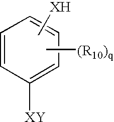

The remainder of the variables, preferred variables and descriptions are as described immediately above, and as described for diacetylated aryl monomers. Deprotection is followed by polymerization of the deprotected aryl monomer, to form a polymer comprising at least one repeat unit selected from:

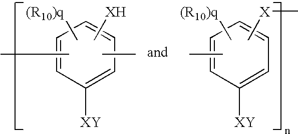

The remainder of the variables, preferred variables and descriptions are as described immediately above, and as described for polymers disclosed herein.

A final deprotection step of the polymer creates an antioxidant polymer comprising at least one repeat unit selected from:

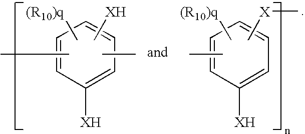

The polymerization conditions are as described herein. The choice of protecting group will depend on the compounds. Protecting groups are selected so that they are suitable for the depicted transformations and can be removed with little or no loss of yield. The introduction and selective removal of protecting groups are taught in Green and Wuts, “Protecting Groups in Organic Synthesis”, John Wiley and Sons, the entire contents of which are incorporated herein by reference.

In certain embodiments the aryl monomer is represented by one of the following structural formulas:

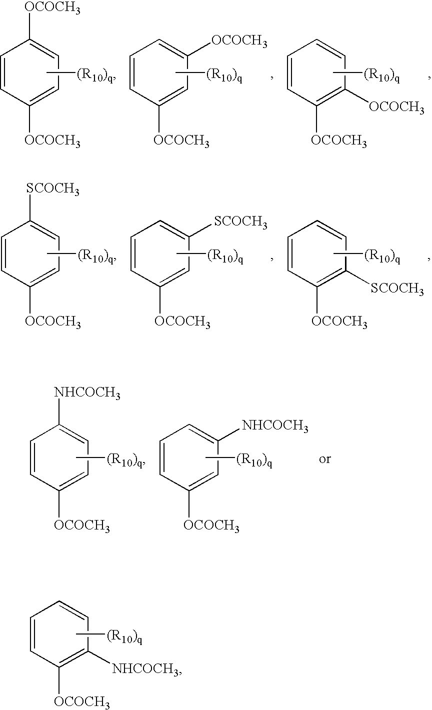

In certain embodiments, the aryl monomer is represented by one of the following structural formulas:

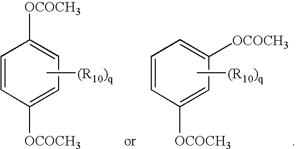

In certain embodiments, the aryl monomer is represented by the following structural formula:

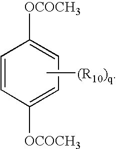

R₁₀ and q are as defined above. Preferably each R₁₀ is independently selected from the groups comprising an optionally substituted C1-C10 alkyl group, an optionally substituted aryl group, an optionally substituted alkoxy group, an optionally substituted alkoxycarbonyl group, an optionally substituted aryloxycarbonyl group, —OH, —SH or —NH₂. More preferably each R₁₀ is independently selected from the groups comprising a tertiary alkyl group (e.g., tert-butyl) or an alkoxy carbonyl group. q is preferably 0 or 1.

In certain embodiments each R₁₀ is independently an optionally substituted C1-C10 alkyl group, an optionally substituted aryl group, and optionally substituted alkoxy group, an optionally substituted carbonyl group, an optionally substituted alkoxycarbonyl group, an optionally substituted aryloxycarbonyl group, and/or two R₁₀ groups on adjacent carbon atoms join together to form an optionally substituted aromatic ring or an optionally substituted carbocyclic or heterocyclic non-aromatic.

In certain embodiments, each R₁₀ is independently C1-C10 alkyl group, or an optionally substituted aryl group, and/or two R₁₀ groups on adjacent carbon atoms join together to form an optionally substituted aromatic ring or an optionally substituted carbocyclic or heterocyclic non-aromatic ring. In certain other embodiments, two R₁₀ groups on adjacent carbon atoms join together to form an optionally substituted non-aromatic heterocyclic ring. In certain embodiments the optionally substituted non-aromatic heterocyclic groups is optionally substituted tetrahydropyranyl or optionally substituted dihydropyranyl. In certain other embodiments the non-aromatic heterocyclic ring is optionally substituted with one or more substituents selected from the group ═O, —OH, C1-C4 alkyl, optionally substituted aryl, —OC(O)(C1-C4 alkyl), —OC(O)(aryl), —OC(O)(substituted aryl), —OC(O)(aralkyl), and —OC(O)(substituted aralkyl).

In certain embodiments, the aryl monomer is represented by the following structural formula:

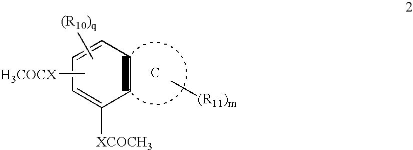

In certain embodiments, Ring C is s five or six membered aromatic or carbocyclic or heterocyclic non- aromatic ring. In certain other embodiments Ring C is a non-aromatic heterocyclic ring. In certain embodiments Ring C is tetrahydropyranyl or dihydropyranyl.

In certain embodiments each R₁₀ is independently C1-C10 alkyl group or an optionally substituted aryl group, —OH, —SH or —NH₂. q is 0 or 1.

In certain other embodiments R₁₁ is ═O, —OH, C1-C4 alkyl, optionally substituted aryl, —OC(O)(C1-C4 alkyl), —OC(O)(aryl), —OC(O)(substituted aryl), —OC(O)(aralkyl), or —OC(O)(substituted aralkyl). In certain other embodiments R₁₁ is ═O, —OH, optionally substituted aryl or —OC(O)(aryl), —OC(O)(substituted aryl). In certain other embodiments R₁₁ is ═O, —OH, optionally substituted phenyl or —OC(O)(phenyl), —OC(O)(substituted phenyl). In certain other embodiments R₁₁ is ═O, —OH, phenol, benzene-diol (pyrocatechol), benzene-triol, —OC(O)(phenol), —OC(O)(benzene-diol), or —OC(O)(benzene-triol,).

m is an integer from 0 to 3.

In certain embodiments, the aryl monomer represented by the following structural formula:

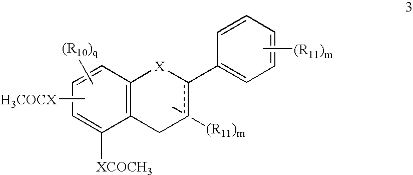

The variables are as described above for structural formula 2. The dashed line represents a double or single bond.

In certain embodiments, the aryl monomer represented by the following structural formula:

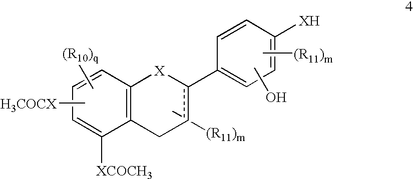

The variables are as described above for structural formula 2. The dashed line represents a double or single bond.

In certain embodiments, the variables and descriptions for the optionally substituted phenol derivatives (phenol derivatives) described herein are as described above for structural formula 1.

In certain embodiments the mono-deacetylation of any monomer described herein can be carried out using a deacetylating catalyst to produce a monoacetylated aryl monomer represented by the following structural formula:

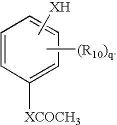

In certain embodiments the mono-deacetylation of an aryl monomer is carried out in an organic solvent using a deacetylating biocatalyst, e.g., a lipase (Novozyme 435 (Candida Antarctica Lipase), candida antarctica lipase, porcine pancreatic lipase, candida rugosa lipase etc.) or a chemical catalyst e.g., a pyrrolidine to form a monoacetylated aryl monomer. In certain embodiments at least one ring carbon atom substituted with an XCOCH₃ or an XH group is adjacent (or ortho) to a ring carbon atom substituted with an R₁₀ group, wherein the R₁₀ group is an optionally substituted C1-C10 alkyl group or an optionally substituted aryl group. In certain embodiments at least one ring carbon atom substituted with an XCOCH₃ or an XH group is meta or para to a ring carbon atom substituted with an R₁₀ group, wherein the R₁₀ group is an optionally substituted C1-C10 alkyl group or an optionally substituted aryl group.

In certain embodiments, as described herein an optionally substituted C1-C10 alkyl, is an unsubstituted C1-C10 alkyl, or a tert-butyl group.

Typically, the acetyl group removed by the deacetylating biocatalyst is the least hindered acetyl group; for example, if there is a tert-butyl group substituent on the aryl monomer, the acetyl group furthest from tert-butyl group is removed.

Typical solvents suitable for mono-deacetylation include organic solvents, such as, toluene, tetrahydrofuran (THF), n-butanol, diisopropylether, dioxane, acetonitrile etc.

The mono-deacetylation reaction can be carried out in certain embodiments at room temperature (22-25° C.), or at elevated temperatures between 25 and 55° C. or between 30 and 40° C. The mono-deacetylation reaction is typically carried out for between 1 and 24 hours, between 2 and 20 hours, between 5 and 15 hours, or between 8 and 12 hours.

The methods of the present invention further include a second step of polymerizing a monoacetylated aryl monomer described herein, to form a polymer comprising at least one repeat unit selected from:

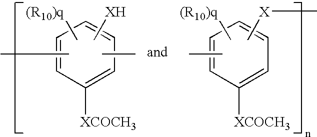

n is an integer greater than or equal to 2. In certain embodiments at least one ring carbon atom substituted with an XCOCH₃ or an XH group is adjacent (or ortho) to a ring carbon atom substituted with an R₁₀ group, wherein the R₁₀ group is an optionally substituted C1-C10 alkyl group or an optionally substituted aryl group. In certain embodiments at least one ring carbon atom substituted with an XCOCH₃ or an XH group is meta orpara to a ring carbon atom substituted with an R₁₀ group, wherein the R₁₀ group is an optionally substituted C1-C10 alkyl group or an optionally substituted aryl group.

In certain embodiments, after deacetylation, an oxidative polymerization catalyst is added along with an oxidant, e.g., hydrogen peroxide or organic peroxide. An oxidative polymerization catalyst is added along with an oxidant, e.g., hydrogen peroxide or organic peroxide to convert the monomer to a polymer.

As used herein the oxidant serves as a substrate for the catalyst. The oxidative polymerization catalyst and oxidant combined facilitate the oxidation of the monomer to form a polymer.

Polymerization of the monomers can be catalyzed by a natural or synthetic enzyme or an enzyme mimetic capable of polymerizing a substituted benzene compound in the presence of hydrogen peroxide, where the enzyme or enzyme mimetic typically have a heme or related group at the active site. One general class of enzymes capable of catalyzing this reaction can be commonly referred to as the peroxidases. Horseradish peroxidase, soybean peroxidase, Coprinus cinereus peroxidase, and Arthromyces ramosus peroxidase are readily available peroxidases. Other enzymes capable of catalyzing the reaction include laccase, tyrosinase, and lipases. Suitable enzymes are able to catalyze the formation of a carbon-carbon bond and/or a carbon-oxygen-carbon bond between two aryl (e.g., phenyl, phenol) groups when a peroxide (e.g., hydrogen peroxide or an organic peroxide) can be present. A subunit or other portion of a peroxidase can be acceptable, provided that the active site of the enzyme can be still functional. Enzyme mimetics typically correspond to a part of an enzyme, so that they can carry out the same reaction as the parent enzyme but are generally smaller than the parent enzyme. Also, enzyme mimetics can be designed to be more robust than the parent enzyme, such as to be functional under a wider variety of conditions (e.g., different pH range, aqueous, partically aqueous and non-aqueous solvents) and less subject to degradation or inactivation. Suitable enzyme mimetics include hematin, tyrosinase-model complexes and iron-salen complexes. Hematin, in particular, can be functionalized to allow it to be soluble under a wider variety of conditions is disclosed in U.S. application Ser. No. 09/994,998, filed Nov. 27, 2001, the entire teachings of which are incorporated herein by reference.

Polymerizations of the present invention can be carried out under a wide variety of conditions. The pH can be often between about pH 1.0 and about pH 12.0, typically between about pH 6.0 and about pH 11.0. The temperature can be above about 0° C., such as between about 0° C. and about 100° C., 0° C. and about 45° C. or between about 15° C. and about 30° C. (e.g., room temperature). The solvent can be aqueous (preferably buffered), organic, or a combination thereof. Organic solvents are typically polar solvents such as ethanol, methanol, isopropanol, dimethylformamide, dioxane, acetonitrile, and diethyl ether. The concentration of monomer or comonomers can be typically 0.001 M or greater. Also, the concentration of buffer can be typically 0.001 M or greater. The polymerization reaction is typically carried out for between 1 and 48 hours, between 10 and 40 hours, between 15 and 35 hours, or between 20 and 30 hours.

Polymerizations of the invention use a catalytic amount of one of the enzymes or enzyme mimetics described above, which can be between about one unit/mL and five units/mL, where one unit can form 1.0 mg purpurogallin from pyrogallol in 20 seconds at pH 6.0 at 20° C. Preferably, the enzyme or enzyme mimetic can be added to the solution after addition of the antioxidant monomer or comonomers. A peroxide can be then added incrementally to the reaction mixture, such as not to de-activate the enzyme or enzyme mimetic, until an amount approximately stoichiometric with the amount of antioxidant monomer or comonomers has been added.

Although the enzyme or enzyme mimetic can be responsible for formation of phenol-based free radicals needed for chain propagation, the coupling of radicals to form a polymer chain can be controlled by the phenoxy radical and solvent chemistries. Further details regarding the coupling of phenoxy radicals can be found in “Enzymatic catalysis in monophasic organic solvents,” Dordick, J. S., Enzyme Microb. Technol. 11:194-211 (1989), the contents of which are incorporated herein by reference. Coupling between substituted benzene monomers typically occurs ortho and/or para to a hydroxyl group. Coupling rarely occurs meta to a hydroxyl group.

Polymerization preferably results in the formation of C—C bonds. Preferred polymers can contain at least about 95% C—C bonds, at least about 90% C—C bonds, at least about 80% C—C bonds, at least about 70% C—C bonds, at least about 60% C—C bonds or at least about 50% C—C bonds. Especially preferred polymers contain about 100% C—C bonds. The remaining bonds are typically C—O—C bonds.

In certain embodiments of the present invention addition of biocatalyst or biomimatic [horseradish peroxidase (HRP), soybean peroxidase, Iron(II)-salen, hematin, and other peroxidases] and hydrogen peroxide (drop wise addition) to the reaction mixture results in the polymerization of monoacetylated phenolic compound.

In certain other embodiments the polymerization is carried out in the presence of an inorganic or organometallic catalyst, such as ferric chloride, ammonium persulphate, Iron(III) chloride, Iron(III) bromide, aluminum chloride, zinc chloride, TEMPO, AIBN, bis(cyclopentadienyl)titanium dichloride, 2.di-alkyl-aluminimum, chloride compounds, 3.triethyl aluminum and titanium tetra chloride, 4.Bis-Cyclopentadienyl, Zirconium Dichloride and 5 Ta(CH-t-Bu)(CH2-t-Bu)₃.

In various embodiments, the monomer for the polymerization can be, for example, a derivative of phenol, aniline, benzenethiol, hydroquinone, aminophenol, phloroglucinol, querectin, epicatechin, epigallocatechin, epicatechingallate and any other polyphenolic, hydroxyl-aniline and hydroxyl-benezethiol system having at least one bulky group ortho-position relative to the phenolic hydroxyl, and their combinations.

In various embodiments, the polymerization can be through, for example, a derivative of phenol, aniline and benzenethiol systems and their combinations.

In certain embodiments the present invention is a method for the synthesis of the macromolecules where the monomer for the polymerization could be, but is not limited to a derivative of hydroquinone, mono-protected hydroquinone, 4-aminophenol, phloroglucinol, querectin, epicatechin, epigallocatechin, epicatechingallate and any other polyphenolic, hydroxyl- aniline and hydroxyl-benezethiol system having at least one bulky group ortho-position with respect to the phenolic hydroxyl and their combinations.

The methods of the present invention further includes a third step of contacting the polymer with an acid to produce a deacetylated antioxidant polymer comprising at least one repeat unit selected from:

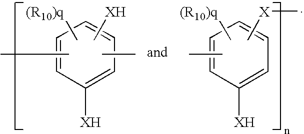

The variables are as described above. In certain embodiments at least one ring carbon atom substituted with an XH group is adjacent (or ortho) to a ring carbon atom substituted with an R₁₀ group, wherein the R₁₀ group is an optionally substituted C1-C10 alkyl group or an optionally substituted aryl group. In certain embodiments at least one ring carbon atom substituted with an XH group is meta orpara to a ring carbon atom substituted with an R₁₀ group, wherein the R₁₀ group is an optionally substituted C1-C10 alkyl group or an optionally substituted aryl group.

In certain embodiments of the present invention, at the end of the polymerization, a drop wise addition of one equivalent of acid e.g. HCl, H₂SO₄ etc. deprotects the other remaining acetyl group in the repeating unit resulting the desired polymeric antioxidant possessing free hydroxyl group. In certain embodiments the free hydroxy group is adjacent to a tert-butyl group in each and every repeating unit of the polymer. In certain embodiments all acetyl groups are deprotected by the methods of the present invention.

In certain embodiments the pH for the polymerization reaction is between about pH 1.0 and about pH 6.0, the temperature is above about 0° C., such as between about 0° C. and about 100° C., 0° C. and about 45° C. or between about 15° C. and about 30° C. (e.g., room temperature). The solvent can be aqueous (preferably buffered), organic, or a combination thereof. Organic solvents are typically polar solvents such as ethanol, methanol, isopropanol, dimethylformamide, dioxane, acetonitrile, and diethyl ether, the reaction times are typically between 1 hr to 24 hrs, 2 hours to 20 hours, 5 hours to 15 hours and 8 hours to 12 hours.

In certain embodiments, for the aryl monomer described herein the ring carbon atom substituted with an —XCOCH₃, —XH, —OH, —SH or NH₂ or protecting group is not adjacent (or ortho) to a ring carbon atom substituted with a C1-C10 alkyl group or aryl group. In certain embodiments the polymers made by the present invention do not have a bulky alkyl group or aryl group adjacent to the —XCOCH₃, —XH, —OH, —SH or NH₂ or protecting group. In certain embodiments, in the polymers made by methods of the present invention the bulky alkyl or aryl group is meta orpara to the —XCOCH₃, —XH, —OH, —SH or NH₂ or protecting group. Without wishing to be bound by any theory it is believed that presence of the bulky group ortho, meta orpara to a hydroxy group (or amino or thiol group) increases the antioxidant activity of the compound. Preferably the bulky group is ortho to the hydroxy group (or amino or thiol group).

In certain embodiments the reaction scheme is represented as follows:

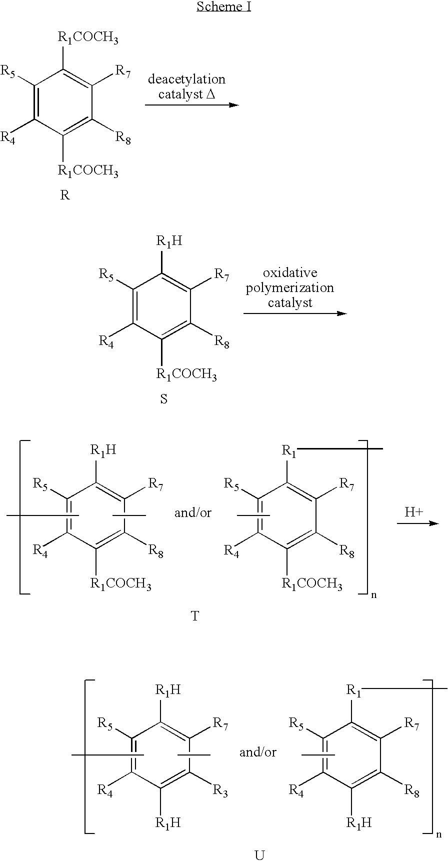

The method of preparing an antioxidant polymer comprises mono-deacetylation of an aryl monomer represented by Structural Formula R in an organic solvent at elevated temperature using a deacetylating biocatalyst, e.g., a lipase, to form a monoacetylated aryl monomer represented by Structural Formula S. After deacetylation, an oxidative polymerization catalyst is added along with an oxidant, e.g., hydrogen peroxide. The monoacetylated phenolic compound reacts to form a polymer represented by Structural Formula T. A final acidic deacetylation step is performed to give the product antioxidant polymer represented by Structural Formula U.

In Structural Formulas R, S, T, and U:

n is an integer equal to or greater than 2;

R₁ is O, S, or NH;

R₄, R₅, R₇ and R₈ are independently —H, —OH, —NH, —SH, a substituted or unsubstituted alkyl or aryl group, or a substituted or unsubstituted alkoxycarbonyl group, or a bond when part of the polymer chain, provided that:
(1) at least one of R₄, R₅, R₇ and R₈ is a tert-butyl group or a substituted or unsubstituted alkoxycarbonyl group, and at least two of R₄, R₅, R₇ and R₈ are —H; or
(2) at least one of R₄, R₅, R₇ and R₈ is a tert-butyl group or a substituted or unsubstituted alkoxycarbonyl group, at least one of R₄, R₅, R₇ and R₈ is a hydroxyl, alkoxy, alkoxycarbonyl or aryloxycarbonyl group, and at least one of R₄, R₅, R₇ and R₈ is —H.

In certain embodiments, after deacetylation, an oxidative polymerization catalyst, is added along with an oxidant, e.g., hydrogen peroxide. The oxidative polymerization catalyst can be, e.g., a biocatalyst or biomimetic such as horseradish peroxidase (HRP), soybean peroxidase, Iron(II)-salen, hematin, and other peroxidases. The monoacetylated phenolic compound represented by Structural Formula S reacts to form a polymer represented by Structural Formula T, where n is at least 2. A final acidic deacetylation step is performed on the polymer represented by Structural Formula D to give a deacetylated polymer represented by Structural Formula U.

In certain other embodiments, the one pot process of the present disclosure involves the treating of mono-diacetylated compound with biocatalysts such as lipases (e.g. candida antarctica lipase, porcine pancreatic lipase, candida rugosa lipase etc.) in organic solvents (toluene, tetrahydrofuran etc.) at elevated temperatures to remove the acetyl group which is farther from tert-butyl group. After completion of the reaction, addition of biocatalyst or biomimatic [horseradish peroxidase (HRP), soybean peroxidase, Iron(II)-salen, hematin, and other peroxidases] and hydrogen peroxide (drop wise addition) to the reaction mixture results in the polymerization of monoacetylated phenolic compound. At the end of the polymerization, a drop wise addition of one equivalent of acid e.g. HCL, H₂SO₄ etc. to the same pot deprotects the other remaining acetyl group in the repeating unit resulting the desired polymeric antioxidant possessing free hydroxyl group preferably next to the tert-butyl group in each and every repeating unit of the polymer, as presented in Scheme II.

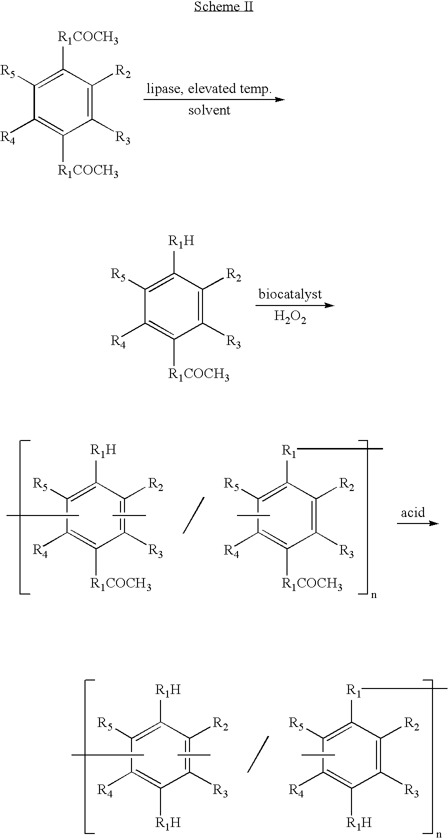

R₁═—O, —NH, etc. R₂, R₃, R₄ and R₅═H, tertbutyl, alkyl, benzyl etc.

As used herein a one pot process can involve one or more steps, however, the products of each step do not have to be isolated or purified between steps and all of the steps can take place on one container.

In a specific embodiment, the antioxidant polymer prepared by the methods of the present invention is represented by one or both of Structural Formulas (Ia)-(Id), and (IIa)-(IId):

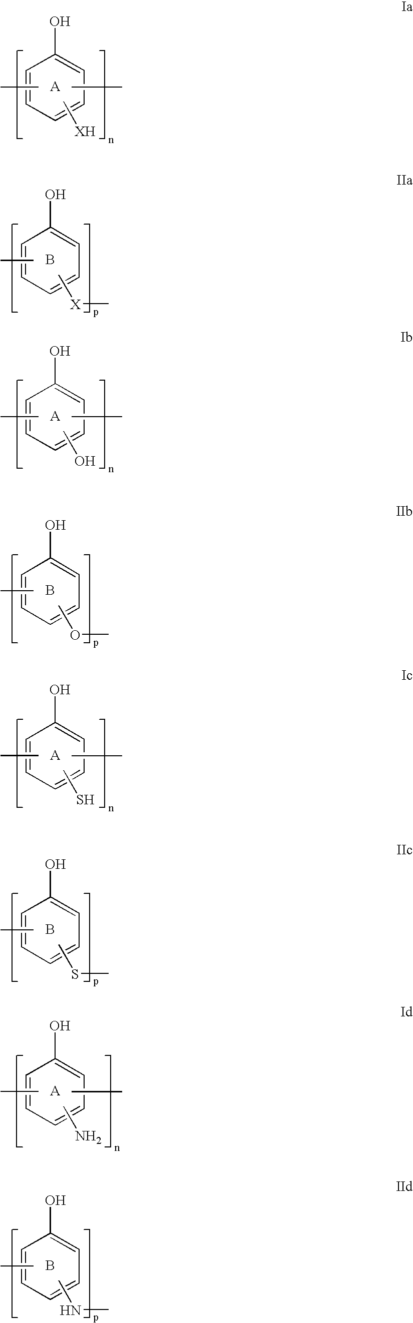

Ring A is substituted with at least one bulky alkyl group preferably a tert-butyl group ortho to the phenolic hydroxy group, and ring A is optionally further substituted with one or more groups selected from a substituted or unsubstituted alkyl or aryl group and a substituted or unsubstituted alkoxycarbonyl group. Ring A is further optionally fused to at least one more optionally substituted aromatic or optionally substituted non-aromatic carbocyclic or heterocyclic group.

Ring B is substituted with at least one —H and at least one bulky group preferably a tert-butyl group ortho to the phenolic hydroxy group, and ring B is further optionally substituted with one or more groups selected from a substituted or unsubstituted alkyl or aryl group and a substituted or unsubstituted alkoxycarbonyl group. Ring B is further optionally fused to at least one more optionally substituted aromatic or optionally substituted non-aromatic carbocyclic or heterocyclic group.

In various embodiments, the alkyl groups substituting Rings A and B can be, for example, secondary and tertiary alkyl groups containing 3 to 10 carbon atoms, typically between 3 and 6. In some embodiments, the alkyl groups are tertiary butyl groups.

X is —O—, —S— or —NH—.

n is an integer equal to or greater than 2; and

p is an integer equal to or greater than 0, wherein the sum of n and p is an integer greater than or equal to 2.

In another embodiment, the antioxidant polymer prepared by the methods of the present invention is represented by one or both of Structural Formulas (I), and (II): 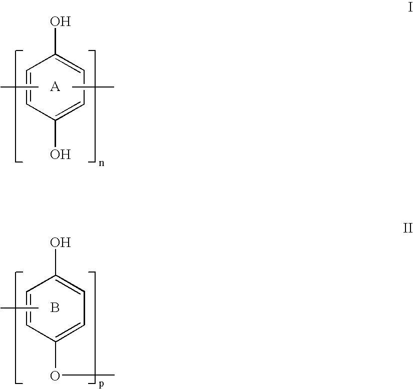
where:

Ring A, Ring B, p and n are as described above

Preferred polymers synthesized by the methods of the present invention include repeat units represented by one or both of Structural Formulas (IIIa) and (IVa): 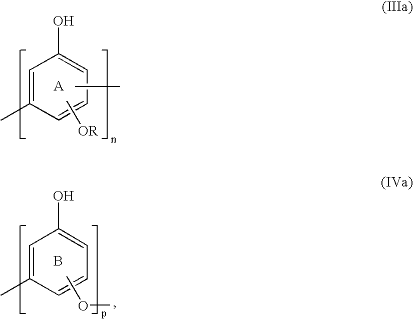
where Rings A and B are substituted as described above and n and p are as defined above.

Preferably, Ring A and Ring B in Structural Formulas (I) to (IV) are each substituted with at least one tert-butyl group located adjacent to the —OH.

R is —H or —CH₃.

Preferred polymers synthesized by the methods of the present invention include repeat units represented by one or both of Structural Formulas (III) and (IV): 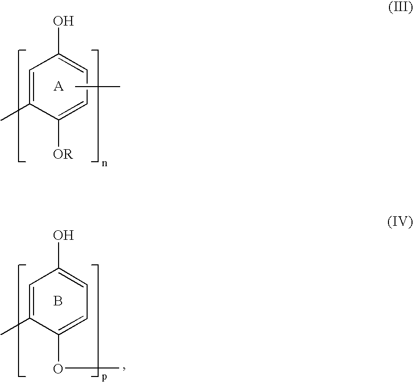
where Rings A and B are substituted as described above and R, n and p are as defined above.

The polymers made by the methods of the present invention can include repeat units represented by one or more of Structural Formulas (Va), (Vb), (Vc), (VIa), (VIb) and (VIc): 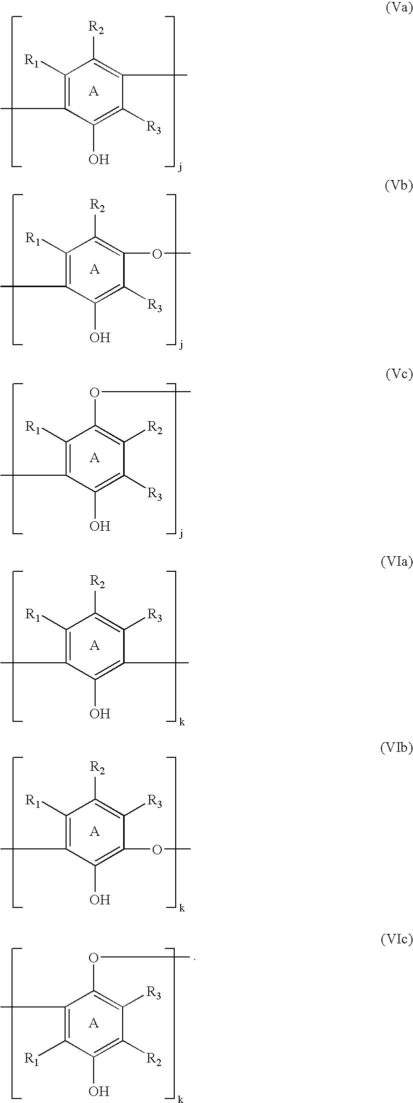
Where R₁, R₂ and R₃ are independently selected from the group consisting of —H, —OH, —NH, —SH, a substituted or unsubstituted alkyl or aryl group, and a substituted or unsubstituted alkoxycarbonyl group, additional values for R₁, R₂ and R₃ include cakoxy and carbonyl. Preferably at least one of R₁, R₂ and R₃ is a tert-butyl group. Preferably the tert-butyl group is adjacent to an —OH group; and j and k are independently integers of zero or greater, such that the sum of j and k is equal

R is —H or —CH₃.

In a specific embodiment, R is —H or —CH₃; R₂ is —H, —OH, or a substituted or unsubstituted alkyl group; or both. Preferably R is —H.

Specific examples of repeat units included in polymers of the present invention are represented by one of the following structural formulas:

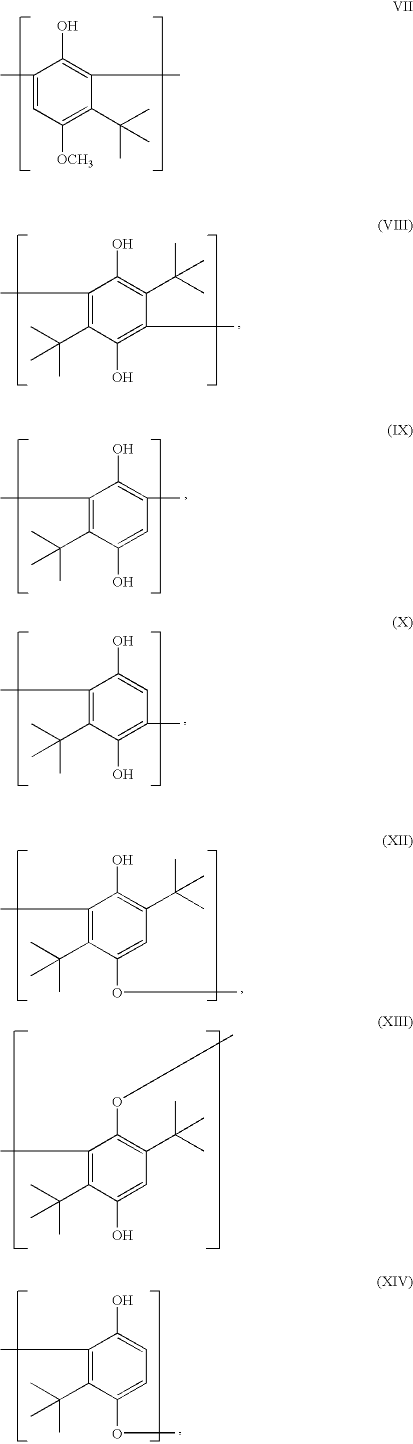

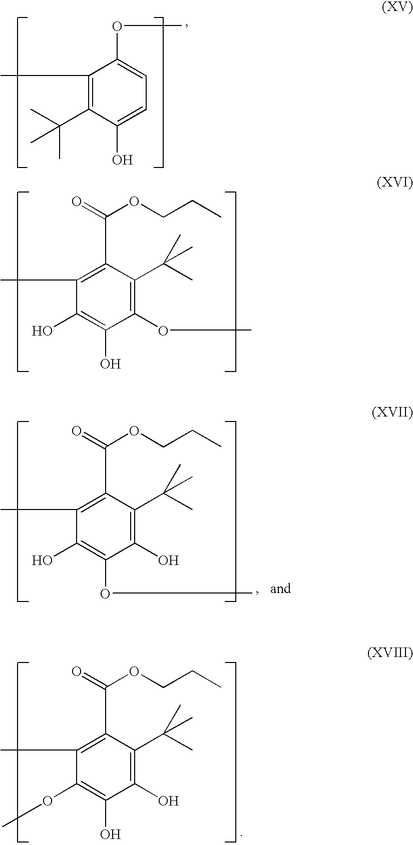

Advantageously, a polymer made by the methods of the present invention consists of repeat units represented by one or more of Structural Formulas (VII) to (XVIII).

Antioxidant polymers made by the methods of the present invention are prepared by polymerizing a molecule represented by Structural Formula (XIX): 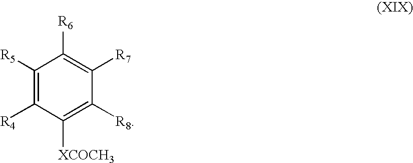
Preferably, a molecule represented by Structural Formula (XIX) has one, two, three, four or five of the following features. In the first feature, at least one of R₅, R₇ and R₈ is a tert-butyl group, —OH, —SH, —NH₂ or XCOCH₃. In the second feature, R₄ is —H, —OH, —SH, —NH₂ or XCOCH₃ In the third feature, one or both of R₇ and R₈ is —H, —OH, —SH, —NH₂ or XCOCH₃. In the fourth feature, R₆ is —H, —OH, —SH, —NH₂ a substituted or unsubstituted alkyl group or XCOCH₃. More preferably, a molecule represented by Structural Formula (XIX) has the first and second features; the first, second and third features; or the first, second, third and fourth features.

Specific examples of monomers that can be polymerized to form an antioxidant polymers of the present invention are represented by one of the following structural formulas:

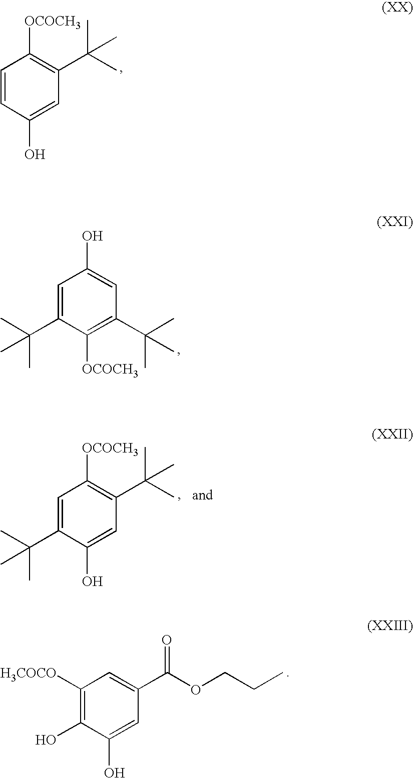

Other examples of specific monomers that can be polymerized to form an antioxidant polymer of the present invention are represented by one of the following structural formulas:

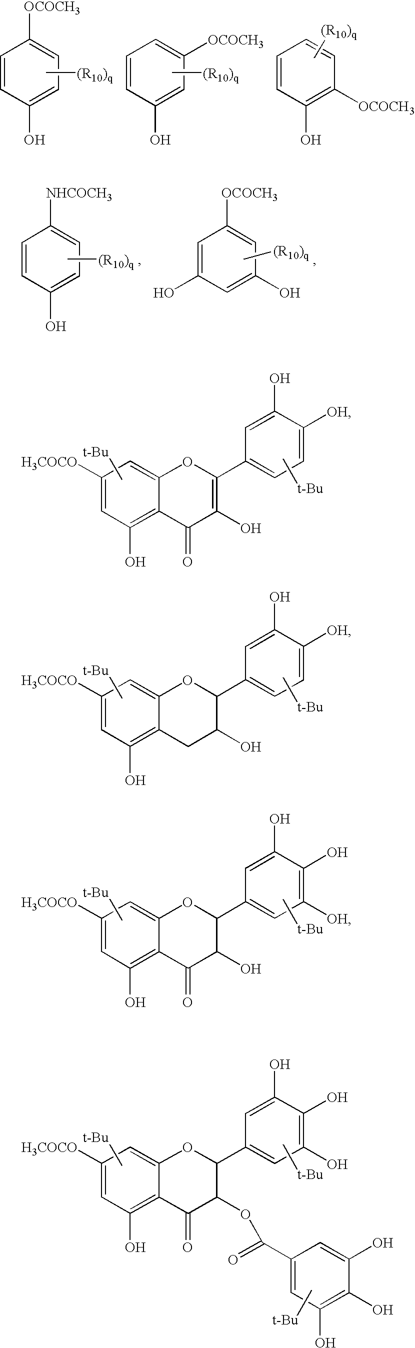

In the above examples the —OH groups can be replaced with OR groups wherein R is as defined above, or —NH₂, —NHR, —SH or —SR.

In all of the examples of monomers and polymers described herein the —OH groups can be replaced with OR, —NH₂, —NHR, —SH or —SR groups wherein R is as defined above.

In certain embodiments, examples of sterically hindered polymeric macromolecular antioxidant produced by the methods of the present invention comprises at least one repeat unit selected from:

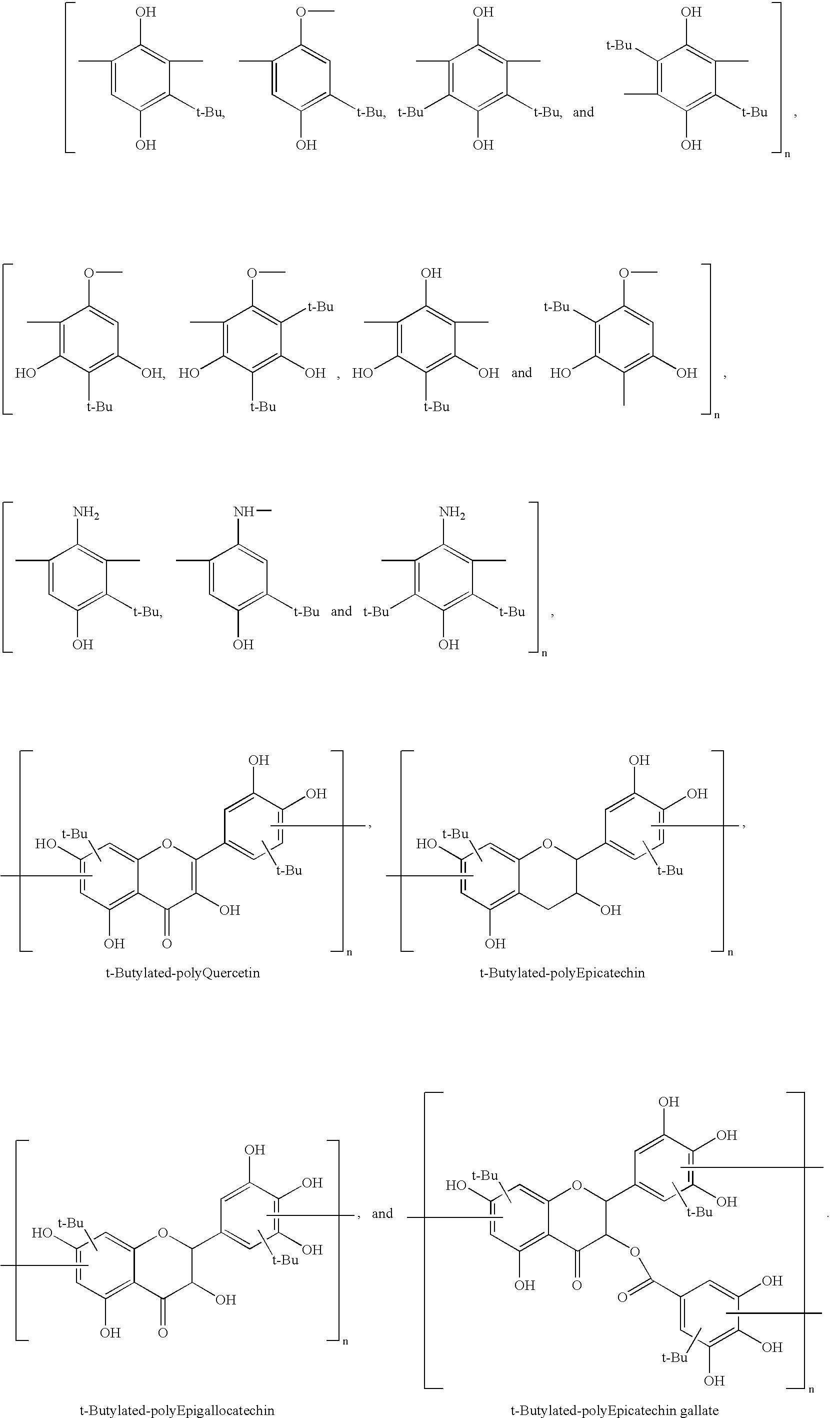

t-Butylated-polyEpicatechin gallate.

The method of preparing an antioxidant polymer comprises mono-deacetylation of an aryl monomer represented by Structural Formula R in an organic solvent at elevated temperature using a deacetylating biocatalyst, e.g., a lipase, to form a monoacetylated aryl monomer represented by Structural Formula S. After deacetylation, an oxidative polymerization catalyst is added along with an oxidant, e.g., hydrogen peroxide. The monoacetylated phenolic compound reacts to form a polymer represented by Structural Formula T. A final acidic deacetylation step is performed to give the product antioxidant polymer represented by Structural Formula U.

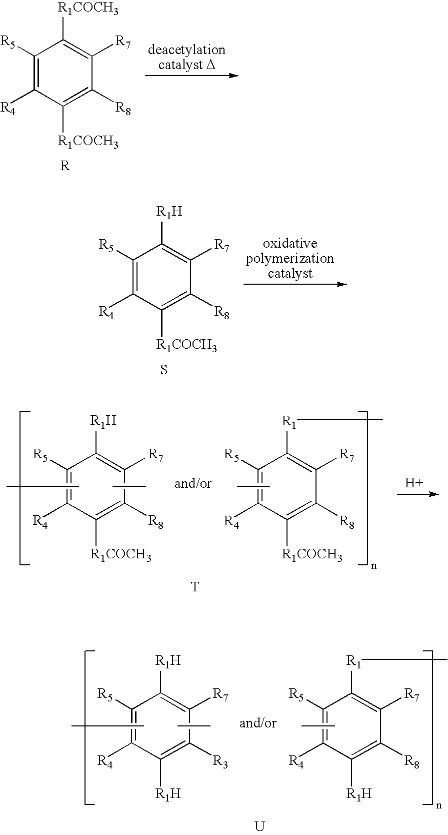

In Structural Formulas R, S, T, and U:

n is an integer equal to or greater than 2;

R₁ is O, S, or NH;

R₄, R₅, R₇ and R₈ are independently —H, —OH, —NH, —SH, a substituted or unsubstituted alkyl or aryl group, or a substituted or unsubstituted alkoxycarbonyl group, or a bond when part of the polymer chain, provided that:
(1) at least one of R₄, R₅, R₇ and R₈ is a tert-butyl group or a substituted or unsubstituted alkoxycarbonyl group, and at least two of R₄, R₅, R₇ and R₈ are —H; or
(2) at least one of R₄, R₅, R₇ and R₈ is a tert-butyl group or a substituted or unsubstituted alkoxycarbonyl group, at least one of R₄, R₅, R₇ and R₈ is a hydroxyl, alkoxy, alkoxycarbonyl or aryloxycarbonyl group, and at least one of R₄, R₅, R₇ and R₈ is —H.

Typically, the acetyl group removed by the deacetylating biocatalyst can be the least hindered acetyl group; for example, when R₃ is a tert-butyl group and R₂, R₄, and R₅ are —H, the acetyl group furthest from R₃ can be removed.

After deacetylation, an oxidative polymerization catalyst, is added along with an oxidant, e.g., hydrogen peroxide. The oxidative polymerization catalyst can be, e.g., a biocatalyst or biomimetic such as horseradish peroxidase (HRP), soybean peroxidase, Iron(II)-salen, hematin, and other peroxidases. The monoacetylated phenolic compound represented by Structural Formula S reacts to form a polymer represented by Structural Formula T, where n is at least 2. A final acidic deacetylation step is performed on the polymer represented by Structural Formula D to give a deacetylated polymer represented by Structural Formula U.

Synthesis of Sterically Hindered Phenol Based Macromolecular Antioxidants

In our earlier work patent applications. 60/370,468, Ser. No. 10/408,679, and PCT/US03/10782, it was demonstrated the synthesis of poly (sterically hindered phenol) antioxidants from substituted phenols using protection and deprotection approach of hydroxyl groups in these phenols. These polymeric antioxidants showed significantly improved antioxidant activities in cooking oils, plastics, lubricants and other industrial applications compared to presently used (monomeric) antioxidants. In one of the preferred methods of making these polymeric antioxidants, demonstrated in our earlier PCT applications, such as in the synthesis of poly (tert-butylhydroquinone), poly(TBHQ), there were four essential and separate steps involved. It also involves the separation of intermediate components at each step. The present invention demonstrates the synthesis by one step process yet involving the same protection and deprotection scheme. The novelty of the present approach is to reduce the required four steps to a single step that is simple and facile

The one pot process of the present disclosure involves the treating of diacetylated compound with biocatalysts such as lipases (e.g. candida antarctica lipase, porcine pancreatic lipase, candida rugosa lipase etc.) in organic solvents (toluene, tetrahydrofuran etc.) at elevated temperatures to remove the acetyl group which is farther from tert-butyl group. After completion of the reaction, addition of biocatalyst or biomimatic [horseradish peroxidase (HRP), soybean peroxidase, Iron(II)-salen, hematin, and other peroxidases] and hydrogen peroxide (drop wise addition) to the reaction mixture results in the polymerization of monoacetylated phenolic compound. At the end of the polymerization, a drop wise addition of one equivalent of acid e.g. HCL, H₂SO₄ etc. to the same pot deprotects the other remaining acetyl group in the repeating unit resulting the desired polymeric antioxidant possessing free hydroxyl group next to the tert-butyl group in each and every repeating unit of the polymer, as presented in Scheme II.

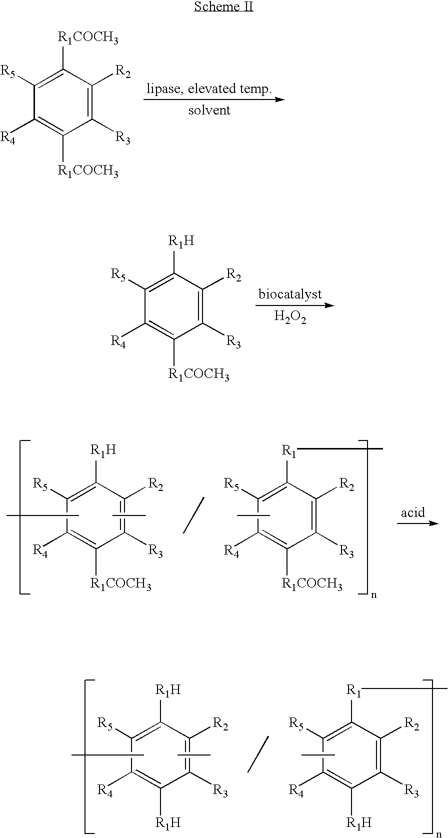

R₁═—O, —NH, etc. R₂, R₃, R₄ and R₅═H, tertbutyl, alkyl, benzyl etc.

Antioxidant polymers of the present invention have two or more repeat units, preferably greater than about five repeat units. The molecular weight of the polymers disclosed herein can be generally selected to be appropriate for the desired application. Typically, the molecular weight can be greater than about 500 atomic mass units (amu) and less than about 2,000,000 amu, greater than about 1,000 amu and less than about 100,000, greater than about 2,000 amu and less than about 10,000, or greater than about 2,000 amu and less than about 5,000 amu. For food or edible products (e.g., products fit for human consumption), the molecular weight can be advantageously selected to be large enough so that an antioxidant polymer cannot be absorbed by the gastrointestinal tract, such as greater than 1,000 amu. For antioxidant polymers blended with a polymeric material, the molecule weight can be advantageously selected such that the rate of diffusion of the antioxidant polymer through the polymeric material can be slow relative to the expected lifetime of the polymeric material.

Antioxidant polymers of the present invention can be either homopolymers or copolymers. A copolymer preferably contains two or more or three or more different repeating monomer units, each of which has varying or identical antioxidant properties. The identity of the repeat units in a copolymer can be chosen to modify the antioxidant properties of the polymer as a whole, thereby giving a polymer with tunable properties. The second, third and/or further repeat units in a copolymer can be either a synthetic or natural antioxidant.

Antioxidant polymers of the present invention are typically insoluble in aqueous media. The solubility of the antioxidant polymers in non-aqueous media (e.g., oils) depends upon the molecular weight of the polymer, such that high molecular weight polymers are typically sparingly soluble in non-aqueous media. When an antioxidant polymer of the invention can be insoluble in a particular medium or substrate, it can be preferably well-mixed with that medium or substrate.

Antioxidant polymers of the present invention can be branched or linear, but are preferably linear. Branched antioxidant polymers can only be formed from benzene molecules having three or fewer substituents (e.g., three or more hydrogen atoms), as in Structural Formulas (XX), (XXI) and (XXIV).

Antioxidant polymers of the present invention can be present in a wide variety of compositions where free radical mediated oxidation leads to deterioration of the quality of the composition, including edible products such as oils, foods (e.g., meat products, dairy products, cereals, etc.), and other products containing fats or other compounds subject to oxidation. Antioxidant polymers can also be present in plastics and other polymers, elastomers (e.g., natural or synthetic rubber), petroleum products (e.g., fossil fuels such as gasoline, kerosene, diesel oil, heating oil, propane, jet fuel), lubricants, paints, pigments or other colored items, soaps and cosmetics (e.g., creams, lotions, hair products). The antioxidant polymers can be used to coat a metal as a rust and corrosion inhibitor. Antioxidant polymers additionally can protect antioxidant vitamins (Vitamin A, Vitamin C, Vitamin E) and pharmaceutical products from degradation. In food products, the antioxidant polymers can prevent rancidity. In plastics, the antioxidant polymers can prevent the plastic from becoming brittle and cracking.

Antioxidant polymers of the present invention can be added to oils to prolong their shelf life and properties. These oils can be formulated as vegetable shortening or margarine. Oils generally come from plant sources and include cottonseed oil, linseed oil, olive oil, palm oil, corn oil, peanut oil, soybean oil, castor oil, coconut oil, safflower oil, sunflower oil, canola (rapeseed) oil and sesame oil. These oils contain one or more unsaturated fatty acids such as caproleic acid, palmitoleic acid, oleic acid, vaccenic acid, elaidic acid, brassidic acid, erucic acid, nervonic acid, linoleic acid, eleosteric acid, alpha-linolenic acid, gamma-linolenic acid, and arachidonic acid, or partially hydrogenated or trans-hydrogenated variants thereof. Antioxidant polymers of the present invention are also advantageously added to food or other consumable products containing one or more of these fatty acids.

The shelf life of many materials and substances contained within the materials, such as packaging materials, are enhanced by the presence of an antioxidant polymer of the present invention. The addition of an antioxidant polymer to a packaging material is believed to provide additional protection to the product contained inside the package. In addition, the properties of many packaging materials themselves, particularly polymers, are enhanced by the presence of an antioxidant regardless of the application (i.e., not limited to use in packaging). Common examples of packaging materials include paper, cardboard and various plastics and polymers. A packaging material can be coated with an antioxidant polymer (e.g., by spraying the antioxidant polymer or by applying as a thin film coating), blended with or mixed with an antioxidant polymer (particularly for polymers), or otherwise have an antioxidant polymer present within it. In one example, a thermoplastic such as polyethylene, polypropylene or polystyrene can be melted in the presence of an antioxidant polymer in order to minimize its degradation during the polymer processing. An antioxidant polymer can also be co-extruded with a polymeric material.

The term “alkyl” as used herein means a saturated straight-chain, branched or cyclic hydrocarbon. When straight-chained or branched, an alkyl group is typically C1-C8, more typically C1-C6; when cyclic, an alkyl group is typically C3-C12, more typically C3-C7 alkyl ester. Examples of alkyl groups include methyl, ethyl, n-propyl, iso-propyl, n-butyl, sec-butyl and tert-butyl and 1,1 -dimethylhexyl.

The term “alkoxy” as used herein is represented by —OR**, wherein R** is an alkyl group as defined above.

The term “carbonyl” as used herein is represented by —C(═O)R**, wherein R** is an alkyl group as defined above.

The term “alkoxycarbonyl” as used herein is represented by —C(═O)OR**, wherein R** is an alkyl group as defined above.

The term “aromatic group” includes carbocyclic aromatic rings and heteroaryl rings. The term “aromatic group” may be used interchangeably with the terms “aryl”, “aryl ring” “aromatic ring”, “aryl group” and “aromatic group”.

Carbocyclic aromatic ring groups have only carbon ring atoms (typically six to fourteen) and include monocyclic aromatic rings such as phenyl and fused polycyclic aromatic ring systems in which a carbocyclic aromatic ring is fused to one or more aromatic rings (carbocyclic aromatic or heteroaromatic)r. Examples include 1-naphthyl, 2-naphthyl, 1-anthracyl and 2-anthracyl. Also included within the scope of the term “carbocyclic aromatic ring”, as it is used herein, is a group in which an aromatic ring is fused to one or more non-aromatic rings (carbocyclic or heterocyclic), such as in an indanyl, phthalimidyl, naphthimidyl, phenanthridinyl, or tetrahydronaphthyl.

The term “heteroaryl”, “heteroaromatic”, “heteroaryl ring”, “heteroaryl group” and “heteroaromatic group”, used alone or as part of a larger moiety as in “heteroaralkyl” refers to heteroaromatic ring groups having five to fourteen members, including monocyclic heteroaromatic rings and polycyclic aromatic rings in which a monocyclic aromatic ring is fused to one or more other aromatic ring (carbocyclic or heterocyclic). Heteroaryl groups have one or more ring heteroatoms. Examples of heteroaryl groups include 2-furanyl, 3-furanyl, N-imidazolyl, 2-imidazolyl, 4-imidazolyl, 5-imidazolyl, 3-isoxazolyl, 4-isoxazolyl, 5-isoxazolyl, oxadiazolyl, oxadiazolyl, 2-oxazolyl, 4-oxazolyl, 5-oxazolyl, N-pyrazolyl, 3-pyrazolyl, 4-pyrazolyl, 5-pyrazolyl, N-pyrrolyl, 2-pyrrolyl, 3-pyrrolyl, 2-pyridyl, 3-pyridyl, 4-pyridyl, 2-pyrimidinyl, 4-pyrimidinyl, 5-pyrimidinyl, 3-pyridazinyl, 4-pyridazinyl, 2-thiazolyl, 4-thiazolyl, 5-thiazolyl, triazolyl, tetrazolyl, 2-thienyl, 3-thienyl, carbazolyl, benzothienyl, benzofuranyl, indolyl, quinolinyl, benzothiazole, benzooxazole, benzimidazolyl, isoquinolinyl and isoindolyl. Also included within the scope of the term “heteroaryl”, as it is used herein, is a group in which an aromatic ring is fused to one or more non-aromatic rings (carbocyclic or heterocyclic).

The term non-aromatic heterocyclic group used alone or as part of a larger moiety refers to non-aromatic heterocyclic ring groups having three to fourteen members, including monocyclic heterocyclcic rings and polycyclic rings in which a monocyclic ring is fused to one or more other non-aromatic carbocyclic or heterocyclic ring or aromatic ring (carbocyclic or heterocyclic). Heterocyclic groups have one or more ring heteroatoms, and can be saturated or unsaturated. Examples of heterocyclic groups include piperidinyl, piperizinyl, pyrrolidinyl, pyrazolidinyl, imidazolidinyl, tetrahydroquinolinyl, inodolinyl, isoindolinyl, tetrahydrofuranyl, oxazolidinyl, thiazolidinyl, dioxolanyl, dithiolanyl, tetrahydropyranyl, dihydropyranyl, azepanyl aNd azetidinyl

The term “heteroatom” means nitrogen, oxygen, or sulfur and includes any oxidized form of nitrogen and sulfur, and the quaternized form of any basic nitrogen. Also the term “nitrogen” includes a substitutable nitrogen of a heteroaryl or non-aromatic heterocyclic group. As an example, in a saturated or partially unsaturated ring having 0-3 heteroatoms selected from oxygen, sulfur or nitrogen, the nitrogen may be N (as in 3,4-dihydro-2H-pyrrolyl), NH (as in pyrrolidinyl) or NR″ (as in N-substituted pyrrolidinyl), wherein R″ is a suitable substituent for the nitrogen atom in the ring of a non-aromatic nitrogen-containing heterocyclic group, as defined below.

As used herein the term non-aromatic carbocyclic ring as used alone or as part of a larger moiety refers to a non-aromatic carbon containing ring which can be saturated or unsaturated having three to fourteen atoms including monocyclic and polycyclic rings in which the carbocyclic ring can be fused to one or more non-aromatic carbocyclic or heterocyclic rings or one or more aromatic (carbocyclic or heterocyclic) rings

An optionally substituted aryl group as defined herein may contain one or more substitutable ring atoms, such as carbon or nitrogen ring atoms. Examples of suitable substituents on a substitutable ring carbon atom of an aryl group include halogen (e.g., —Br, Cl, I and F), —OH, C1-C4 alkyl, C1-C4 haloalkyl, —NO₂, C1-C4 alkoxy, C1-C4 haloalkoxy, —CN, —NH₂, C1-C4 alkylamino, C1-C4 dialkylamino, —C(O)NH₂, —C(O)NH(C1-C4 alkyl), —C(O)(C1-C4 alkyl), —OC(O)(C1-C4 alkyl), —OC(O)(aryl), —OC(O)(substituted aryl), —OC(O)(aralkyl), —OC(O)(substituted aralkyl), —NHC(O)H, —NHC(O)(C1-C4 alkyl), —C(O)N(C1-C4 alkyl)₂, —NHC(O)O—C1-C4 alkyl), —C(O)OH, —C(O)O—(C1-C4 alkyl), —NHC(O)NH₂, —NHC(O)NH(C1-C4 alkyl), -NHC(O)N(C1-C4 alkyl)₂, —NH—C(═NH)NH₂, —SO₂NH₂—SO₂NH(C1-C3alkyl), —SO₂N(C1-C3alkyl)₂, NHSO₂H, NHSO₂(C1-C4 alkyl) and optionally substituted aryl. Preferred substituents on aryl groups are as defined throughout the specification. In certain embodiments aryl groups are unsubstituted.

Examples of suitable substituents on a substitutable ring nitrogen atom of an aryl group include C1-C4 alkyl, NH₂, C1-C4 alkylamino, C1-C4 dialkylamino, —C(O)NH₂, —C(O)NH(C1-C4 alkyl), —C(O)(C1-C4 alkyl), —CO₂R**, —C(O)C(O)R**, —C(O)CH₃, —C(O)OH, —C(O)O—(C1-C4 alkyl), —SO₂NH₂—SO₂NH(C1-C3alkyl), —SO₂N(C1-C3alkyl)₂, NHSO₂H, NHSO₂(C1-C4 alkyl), -C(═S)NH₂, —C(═S)NH(C1-C4 alkyl), —C(═S)N(C1-C4 alkyl)₂, —C(═NH)—N(H)₂, —C(═NH)—NH(C1-C4 alkyl) and —C(═NH)—N(C1-C4 alkyl)₂,

An optionally substituted alkyl group or non-aromatic carbocyclic or heterocyclic group as defined herein may contain one or more substituents. Examples of suitable substituents for an alkyl group include those listed above for a substitutable carbon of an aryl and the following: ═O, ═S, ═NNHR**, ═NN(R**)₂, ═NNHC(O)R**, ═NNHCO₂ (alkyl), ═NNHSO₂ (alkyl), ═NR**, spiro cycloalkyl group or fused cycloalkyl group. R** in each occurrence, independently is —H or C1-C6 alkyl. Preferred substituents on alkyl groups are as defined throughout the specification. In certain embodiments optionally substituted alkyl groups are unsubstituted.

A “spiro cycloalkyl” group is a cycloalkyl group which shares one ring carbon atom with a carbon atom in an alkylene group or alkyl group, wherein the carbon atom being shared in the alkyl group is not a terminal carbon atom.

Examples of other suitable substituents on an alkyl, aryl or acyl group may include, for example, halogen (—Br, —Cl, —I and —F), —ORₐ, —CN, —NO₂, —N(Rₐ)₂, —COORₐ, —CON(Rₐ)₂, —SOₖRₐ (k is 0, 1 or 2) and —NH—C(═NH)—NH₂. An alkyl group can also have ═O or ═S as a substituent. Each Rₐ is independently —H, an alkyl group, a substituted alkyl group, a benzyl group, a substituted benzyl group, an aryl group or a substituted aryl group. A substituted benzylic group or aryl group can also have an alkyl or substituted alkyl group as a substituent. A substituted alkyl group can also have a benzyl, substituted benzyl, aryl or substituted aryl group as a substituent. A substituted alkyl, substituted aryl or substituted acyl group can have more than one substituent.

Further examples of suitable substituents on an alkyl, aryl or acyl group may include, for example, halogen (—Br, —Cl, —I and —F), —ORₐ, —CN, —NO₂, —N(Rₐ)₂, —COORₐ, —CON(Rₐ)₂, —SOₖRₐ (k is 0, 1 or 2) and —NH—C(═NH)—NH₂. An alkyl group can also have ═O or ═S as a substituent. Each Rₐ is independently —H, an alkyl group, a substituted alkyl group, a benzyl group, a substituted benzyl group, an aryl group or a substituted aryl group. A substituted benzylic group or aryl group can also have an alkyl or substituted alkyl group as a substituent. A substituted alkyl group can also have a benzyl, substituted benzyl, aryl or substituted aryl group as a substituent. A substituted alkyl, substituted aryl or substituted acyl group can have more than one substituent.

Without wishing to be bound by any theory or limited to any mechanism it is believed that macromolecular antioxidants and polymeric macromolecular antioxidants of the present invention exploit the differences in activities (ks, equilibrium constant) of, for example, homo- or hetero- type antioxidant moieties. Antioxidant moieties include, for example, hindered phenolic groups, unhindered phenolic groups, aminic groups and thioester groups, etc. of which there can be one or more present in each macromolecular antioxidant molecule. As used herein a homo- type antioxidant macromolecule comprises antioxidant moieties which are all same, for example, hindered phenolic, —OH groups. As used herein a hetero- type antioxidant macromolecule comprises at least one different type of moiety, for example, hindered phenolic and aminic groups in the one macromolecule.

This difference in activities can be the result of, for example, the substitutions on neighboring carbons or the local chemical or physical environment (for example, due to electrochemical or stereochemical factors) which can be due in part to the macromolecular nature of molecules.

In one embodiment of the present invention, a series of macromolecular antioxidant moieties of the present invention with different chemical structures can be represented by W1H, W2H, W3H, . . . to WnH. In one embodiment of the present invention, two types of antioxidant moieties of the present invention can be represented by: W1H and W2H. In certain embodiments W1H and W2H can have rate constants of k1 and k2 respectively. The reactions involving these moieties and peroxyl radicals can be represented as: 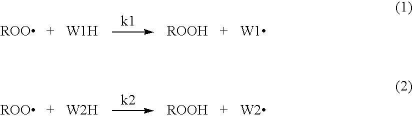
where ROO. is a peroxyl radical resulting from, for example, initiation steps involving oxidation activity, for example:
RH→R.+H. (3)
R.+O2→ROO. (4)

In one particular embodiment of the present invention k1>>k2 in equations (1) and (2). As a result, the reactions would take place in such a way that there is a decrease in concentration of W1. free radicals due their participation in the regeneration of active moiety W2H in the molecule according equation (5):
W1.+W2H→W1H+W2. (5) (transfer equilibrium)

This transfer mechanism may take place either in intra- or inter-molecular macromolecules. The transfer mechanism (5) could take place between moieties residing on the same macromolecule (intra-type) or residing on different macromolecules (inter-type).

In certain embodiments of the present invention, the antioxidant properties described immediately above (equation 5) of the macromolecular antioxidants and polymeric macromolecular antioxidants of the present invention result in advantages including, but not limited to:
a) Consumption of free radicals W1. according to equation (5) can result in a decrease of reactions of W1. with hydroperoxides and hydrocarbons (RH).
b) The regeneration of W1H provides extended protection of materials. This is a generous benefit to sacrificial type of antioxidants that are used today. Regeneration of W1H assists in combating the oxidation process The increase in the concentration of antioxidant moieties W1H (according to equation 5) extends the shelf life of materials.

In certain embodiments of the present invention, the following items are of significant interest for enhanced antioxidant activity in the design of the macromolecular antioxidants and polymeric macromolecular antioxidants of the present invention:
a) The activity of proposed macromolecular antioxidant is dependent on the regeneration of W1H in equation (5) either through inter- or intra-molecular activities involving homo- or hetero-type antioxidant moieties.
b) Depending on the rates constants of W1H and W2H it is possible to achieve performance enhancements by many multiples and not just incremental improvements.

In certain embodiments of the present invention, more than two types of antioxidant moieties with different rate constants are used in the methods of the present invention.

The entire contents of each of the following are incorporated herein by reference.
Docket No.: 3805.1000-000; Provisional Patent Application No.: 60/632,893, filed Dec. 3, 2004, Title: Process For The Synthesis Of Polyalkylphenol Antioxidants, by Suizhou Yang, et al;
Docket No.: 3805.1000-001; filed Dec. 2, 2005, Title: Process For The Synthesis Of Polyalkylphenol Antioxidants, by Suizhou Yang, et al;
Docket No.: 3805.1001-000; Provisional Patent Application No.: 60/633,197, filed Dec. 3, 2004, Title: Synthesis Of Sterically Hindered Phenol Based Macromolecular Antioxidants, by Ashish Dhawan, et al.;
Docket No.: 3805.1001-001; filed Dec. 2, 2005, Title: Synthesis Of Sterically Hindered Phenol Based Macromolecular Antioxidants, by Ashish Dhawan, et al.;
Docket No.: 3805.1003-000; Provisional Patent Application No.: 60/633,196, filed Dec. 3, 2004, Title: Synthesis Of Aniline And Phenol-Based Macromonomers And Corresponding Polymers, by Rajesh Kumar, et al.;
Docket No.: 3805.1003-001; filed Dec. 2, 2005, Title: Synthesis Of Aniline And Phenol-Based Macromonomers And Corresponding Polymers, by Rajesh Kumar, et al.;
Docket No.: 3805.1004-002; patent application Ser. No.: 11/184,724, filed Jul. 19, 2005, Title: Anti-Oxidant Macromonbmers And Polymers And Methods Of Making And Using The Same, by Ashok L. Cholli;
Docket No.: 3805.1004-005; patent application Ser. No.11/184,716, filed Jul. 19, 2005, Title: Anti-Oxidant Macromonomers And Polymers And Methods Of Making And Using The Same, by Ashok L. Cholli;
Docket No.: 3805.1005-000; Provisional Patent Application No.: 60/655,169, filed Feb. 22, 2005, Title: Nitrogen And Hindered Phenol Containing Dual Functional Macromolecules: Synthesis And Their Antioxidant Performances In Organic Materials, by Rajesh Kumar, et al.
Docket No.: 3805.1006-000; Provisional Patent Application No.: 60/655,169, filed Mar. 25, 2005, Title: Alkylated Macromolecular Antioxidants And Methods Of Making, And Using The Same, by Rajesh Kumar, et al.
Docket No.: 3805.1007-000; Provisional Patent Application No. 60/731,125, filed Oct. 27, 2005, Title: Macromolecular Antioxidants And Polymeric Macromolecular Antioxidants, by Ashok L. Cholli, et al.
Docket No.: 3805.1008-000; Provisional Patent Application No. 60/731,021, filed Oct. 27, 2005, Title: Macromolecular Antioxidants Based On Sterically Hindered Phenols And Phosphites, by Ashok L. Cholli, et al.
Docket No.: 3805.1009-000; Provisional Patent Application, filed Dec. 2, 2005, Title: Lubricant Composition, by Kumar, Rajesh, et al.
Docket No.: 3805.1010-000; Provisional Patent Application No. 60/731,325, filed Oct. 27, 2005, Title: Stabilized Polyolefin Composition, by Kumar, Rajesh, et al.
Docket No.: 0813.2006-003; patent application Ser. No. 11/040,193, filed Jan. 21 2005, Title: Post-Coupling Synthetic Approach For Polymeric Antioxidants, by Ashok L. Choll, et al.;
Docket No.: 0813.2006-002; Patent Application No.: PCT/US2005/001948, filed Jan. 21, 2005, Title: Post-Coupling Synthetic Approach For Polymeric Antioxidants, by Ashok L. Cholli et al.;
Docket No.: 0813.2002-008; Patent Application No.: PCT/US2005/001946, filed Jan. 21 2005, Title: Polymeric Antioxidants, by Ashok L. Choll, et al.;
Docket No.: 0813.2002-006; Patent Application No.: PCT/US03/10782, filed Apr. 4, 2003, Title: Polymeric Antioxidants, by Ashok L. Choll, et al.;
Docket No.: 0813.2002-004; patent application Ser. No.: 10/761,933, filed Jan. 21, 2004, Title: Polymeric Antioxidants, by Ashish Dhawan, et al.;
Docket No.: 0813.2002-001; patent application Ser. No.: 10/408,679, filed Apr. 4, 2003, Title: Polymeric Antioxidants, by Ashok L. Choll, et al.;
Tertiary Butoxy Derivatives of Phenol. (Jan Pospisil and Ludek Taimr). (1964), 2 pp. CS 111291
A New Synthesis of aryl tert-butyl Ethers. Masada, Hiromitsu; Oishi, Yutaka. Fac. Eng., Kanazawa Univ., Kanazawa, Japan. Chemistry Letters (1978), (1), 57-8.
Simple Synthesis of the tert-butyl Ether of Phenol. Ol'dekop, Yu. A.; Maier, N. A.; Erdman, A. A.; Shirokii, V. L.; Zubreichuk, Z. P.; Beresnevich, L. B. Inst. Fiz.-Org. Khim., Minsk, USSR. Zhumal Obshchei Khimii (1980), 50(2), 475-6.
New Method for the Williamson Ether Synthesis Using tert-alkyl Halides in Nonpolar Solvents. Masada, Hiromitsu; Mikuchi, Fumio; Doi, Yasuo; Hayashi, Akira. Dep. Chem. Chem. Eng., Kanazawa Univ., Kanazawa, Japan. Nippon Kagaku Kaishi (1995), (2), 164-6.
New Heterogeneous Williamson Synthesis of Ethers Using tert-alkyl Substrates. Masada, Hiromitsu; Doi, Yasuo; Mikuchi, Fumio; Keiko, Kigoshi. Faculty Eng., Kanazawa Univ., Kanazawa, Japan. Nippon Kagaku Kaishi (1996), (3), 275-82.
Preparation of Aromatic Tertiary Ethers. Tanaka, Masato; Reddy, Nagaveri Prabacal. (Agency of Industrial Sciences and Technology, Japan). Jpn. Kokai Tokkyo Koho (1999), 3 pp. JP 080063.
Preparation of Aromatic Ethers. Watanabe, Makoto; Koie, Yasuyuki. (Tosoh Corp., Japan). Jpn. Kokai Tokkyo Koho (1999), 10 pp. JP 11158103.
o-Alkylated phenols. Firth, Bruce E.; Rosen, Terry J. (UOP Inc., USA). U.S. Pat. No. 4,447,657 (1984), 4 pp.
2-Tert-Butyl-4-alkoxy- and -4-hydroxyphenols. Firth, Bruce E.; Rosen, Terry J. (UOP Inc., USA). U.S. Pat. No. 4,465,871 (1984), 4 pp.
Conversion of Alkyl Phenyl Ether to Alkylphenol. Klicker, James D. (Borg-Warner Corp., USA). U.S. Pat. No. 4,283,572 (1981), 3 pp.
O. N. Tsevktov, K. D. Kovenev, Int. J. Chem. Eng. 6 (1966), 328.
Sartori Giovanni, Franca Bigi et al., Chem. Ind. (London), 1985 (22) 762-763.
V. A. Koshchii, Ya. B Kozlikovskii, A. A Matyusha, Zh. Org. Khim. 24(7), 1988, 1508-1512.
Gokul K. Chandra, M. M. Sharma, Catal. Lett. 19(4), 1993, 309-317.
Sakthivel, Ayyamperumal; Saritha, Nellutla; Selvam, Parasuraman, Catal. Lett. 72(3), 2001, 225-228.
V. Quaschning, J. Deutsch, P. Druska, H. J. Niclas and E. Kemnitz. J. Catal. 177 (1998), p. 164.
S. K. Badamali, S. Sakthivel and P. Selvam. Catal. Today 63 (2000), p. 291.
A. Heidekum, M. A. Hamm and F. Hoelderich. J. Catal. 188 (1999), p. 230.
Y. Kamitori, M. Hojo, R. Matsuda, T. Izumi and S. Tsukamoto. J. Org. Chem. 49 (1984), p. 4165.
E. Armengol, A. Corma, H. Garcia and J. Primo. Appl. Catal. A 149 (1997), p. 411.
J. M. Lalancette, M. J. Fournier and R. Thiffault. Can. J. Chem. 52 (1974), p. 589.
Japanese Patent No. JP 145002980, 1970.
Japanese Patent No. 44028850, 1969.
Japanese Patent No. 44024274, 1969.

### EXEMPLIFICATION

The formation of macromolecular antioxidants are illustrated with following examples.

### EXAMPLE 1

### Formation of Diacetate of TBHQ (Scheme III)

In the case of poly-tert-butylhydroquinone (poly-TBHQ), for example, the starting monomeric material can be commercially available tert-butylhydroquinone diacetate. Alternatively, the starting material (diacetate of TBHQ) can be synthesized from tert-butylhydroquinone as shown below. 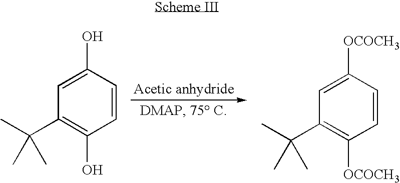
700 gm of TBHQ was dissolved in 500 ml of acetic anhydride (which can function as acetylating agent as well as solvent for this reaction step) in a 21 round bottom flask. A catalytic amount (0.1 eq., 50 gram) of 4-(Dimethylamino) pyridine [DMAP] was added to a reaction mixture at 75° C. temperature under N₂ atmosphere. The reaction was monitored by thin layer chromatography (TLC). After complete consumption of the starting material (TBHQ), acetic anhydride was removed using a rotary evaporator. The residue was then poured slowly in ice cooled water, filtered and washed thoroughly to give solid TBHQ diacetate.

### EXAMPLE 2

### One Pot Synthesis Process of Poly (TBHQ) at 1 kg Scale

1 kg of TBHQ diacetate was dissolved in 1 liter of tetrahydrofuran (THF). To the reaction mixture, 100 gm of Novozyme 435 (Candida Antarctica Lipase., 10% of substrate) and 326 gm of n-butanol (1.1 eq. of diacetate of TBHQ) was added (Step a in Scheme IV). 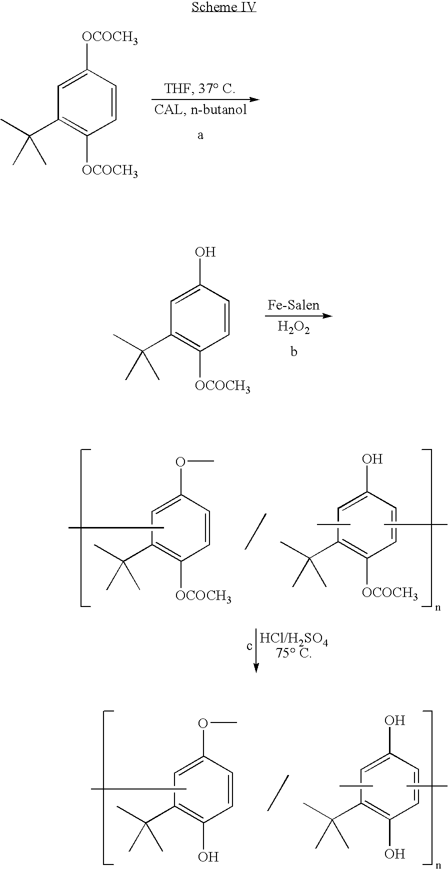
The reaction was performed at 37° C. temperature in a closed flask and was monitored by TLC. After consumption of the starting material (TBHQ diacetate), Novozyme 435 was filtered off from the reaction mixture and washed with THF. The filtrate containing TBHQ monoacetate in THF was used as is and was diluted to 10 liters (1:10) by adding THF for the polymerization step. 20 gm of Fe-Salen (ca 2% of substrate) was added to the reaction mixture (Step b in Scheme IV), followed by H₂O₂ solution (1.7 liters, 10% solution) drop wise to the THF solution. The reaction was stirred under air at room temperature and was monitored by TLC. After complete consumption of TBHQ monoacetate, 1 eq HCl (474 ml of 37% HCl) was added drop wise to deprotect the remaining acetyl group (Step c in Scheme IV). The reaction was then refluxed and the product formation was monitored by NMR spectroscopy. The complete disappearance of a peak at 2.3 ppm representing the acetyl group signifies the removal of acetyl group. At this stage, THF was removed completely from the reaction mixture. The residue was then dissolved in 1 liter of methanol and methanol solution was poured slowly into ice cooled water to get the product poly (TBHQ) as light brown powder.

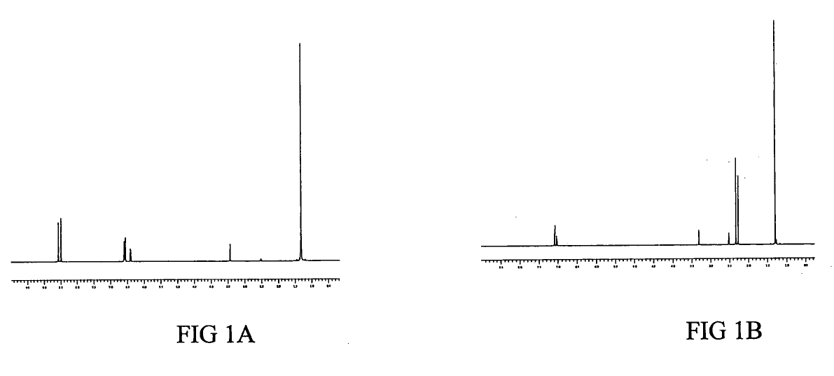

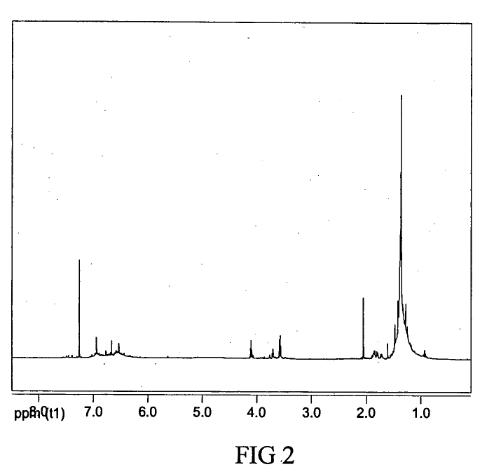

FIG. 1 shows the high resolution 500 MHz ¹H NMR spectra of TBHQ (a) and high resolution 500 MHz ¹H NMR spectra of diacetate of TBHQ (b). In the ¹H NMR spectrum of diacetate (Spectrum b), the appearance of peaks at 2.2 and 2.3 ppm proves the formation of diacetate. FIG. 2 shows the high resolution 500 MHz ¹H NMR spectra of desired poly (TBHQ). Disappearance of peaks at 2.2 and 2.3 ppm in the ¹H NMR spectrum of poly (TBHQ) in FIG. 2 suggested the complete removal of acetyl group from the polymerized material.

### EXAMPLE 3

### Poly (TBHQ) is an Effective Antioxidant

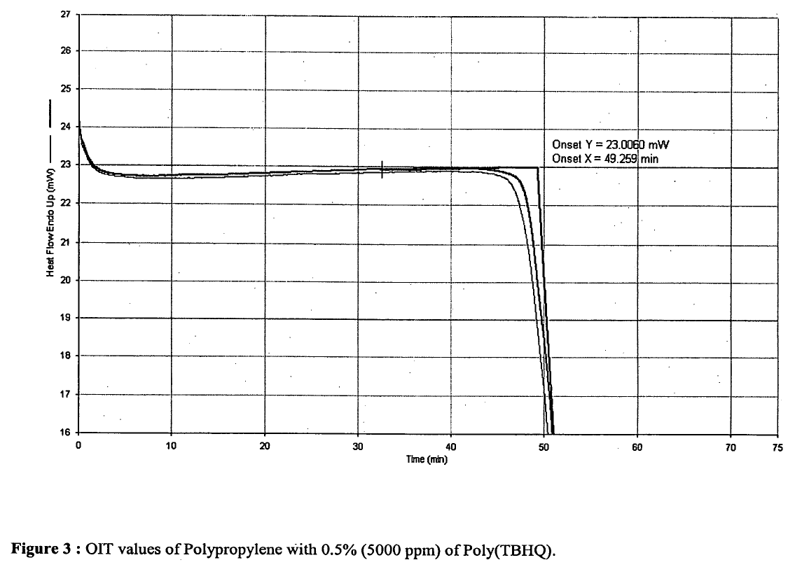

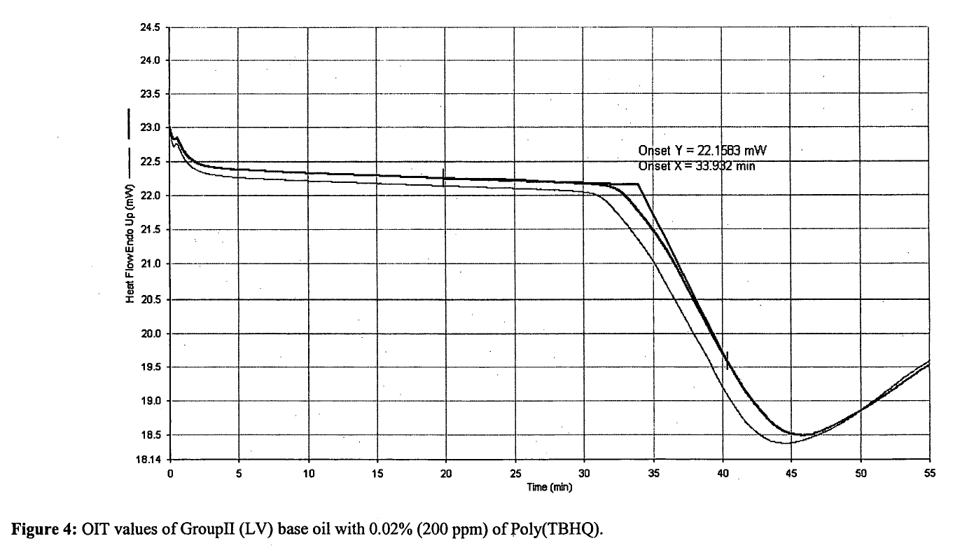

The oxidative induction time (OIT) of polyolefins (ASTM D-3835 method) and lubricants with poly (TBHQ) was determined using industrial standard methods by differential scanning calorimetry (DSC). FIG. 3 shows the oxidative induction time of poly(TBHQ) made as described in Example 2 in polypropylene. FIG. 4 shows the oxidative induction time of poly(TBHQ) ) made as described in Example 2 in Group II (LV) base oil. Performance of poly (TBHQ) synthesized by one pot process described in this disclosure is comparable to the product of the previous four step approach described in patent applications 60/370,468, Ser. No. 10/408,679, and PCT/US03/10782.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of synthesizing an antioxidant polymer, comprising the steps of:
a) mono-deacetylating an aryl monomer represented by the following structural formula: 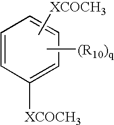
wherein:
at least one ring carbon atom substituted with an XCOCH₃ group is adjacent to a ring carbon atom substituted with an optionally substituted C1-C10 alkyl group or an optionally substituted aryl group;
each X is independently —O—, —NH— or —S—;
each R₁₀ is independently an optionally substituted C1-C10 alkyl group, an optionally substituted aryl group, and optionally substituted alkoxy group, an optionally substituted carbonyl group, an optionally substituted alkoxycarbonyl group, an optionally substituted aryloxycarbonyl group, —OH, —SH or —NH₂; and/or two R₁₀ groups on adjacent carbon atoms join together to form an optionally substituted aromatic ring or an optionally substituted carbocyclic or heterocyclic non-aromatic ring; and
q is an integer from 1 to 2;
in the presence of a deacetylating catalyst to produce a monoacetylated aryl monomer represented by the following structural formula: 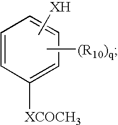
b) polymerizing the monoacetylated aryl monomer, to form a polymer comprising at least one repeat unit selected from: 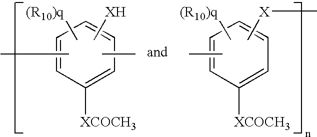
n is an integer greater than or equal to 2;
c) contacting the polymer with an acid to produce a deacetylated antioxidant polymer comprising at least one repeat unit selected from:

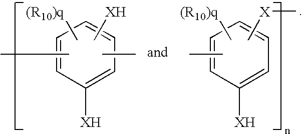

2. The method of claim 1, wherein the polymerization in step b) is carried out in the presence of a biocatalyst or biomimetic catalyst selected from Iron(II)-salen complexes, horseradish peroxidase (HRP), soybean peroxidase (SBP), hematin, laccase, tyroniase, and a tyroniase-model complex.

3. The method of claim 1, wherein the polymerization in step b) is carried out in the presence of an inorganic or organometallic catalyst.

4. The method of claim 1, wherein the deacetylating catalyst in step a)is a biocatalyst.

5. The method of claim 4, wherein the biocatalyst is a lipase selected from candidia antarctica lipase, porcine pancreatic lipase or candidia rugosa lipase.

6. The method of claim 1, wherein the deacetylating catalyst in step a) is pyrrolidone.

7. The method of claim 1, wherein the acid in step c) is hydrochloric acid of sulfuric acid.

8. The method of claim 1, wherein at least one R₁₀ is a C1-C 10 alkyl group.

9. The method of claim 1 wherein at least one X is —O—.

10. The method of claim 9, wherein the aryl monomer in step a) is represented by the following structural formula:

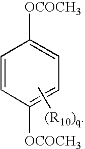

11. The method of claim 10, wherein the deacetylated antioxidant polymer produced in step c) comprises at least one repeat unit selected from:

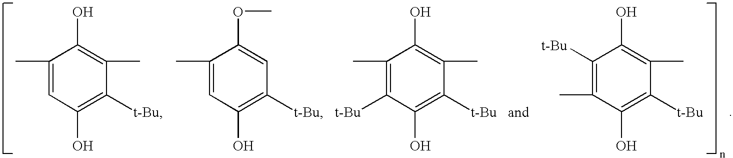

12. The method of claim 9, wherein the aryl monomer in step a) is represented by the following structural formula:

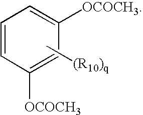

13. The method of claim 9, wherein the aryl monomer in step a) is represented by the following structural formula:

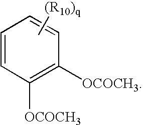

14. The method of claim 9, wherein the aryl monomer in step a) is represented by the following structural formula: 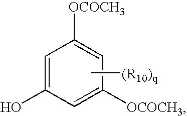
wherein:
q is 0 or 1.

15. The method of claim 14, wherein the deacetylated antioxidant polymer produced in step c) comprises at least one repeat unit selected from:

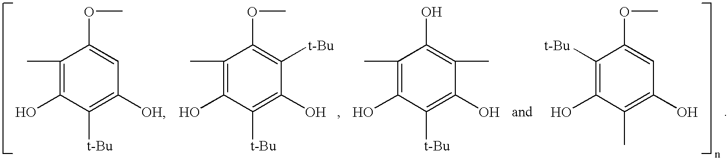

16. The method of claim 9, wherein at least one X is —NH—.

17. The method of claim 16, wherein the aryl monomer in step a) is represented by the following structural formula:

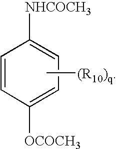

18. The method of claim 17, wherein the deacetylated antioxidant polymer produced in step c) comprises at least one repeat unit selected from:

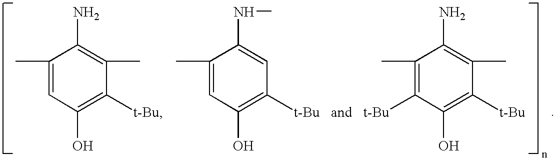

19. The method of claim 1, wherein each R₁₀ is independently C1-C 10 alkyl, —OH, —SH or —NH₂, or two R₁₀ groups on adjacent carbon atoms join together to form an optionally substituted aromatic ring or an optionally substituted carbocyclic or heterocyclic non-aromatic ring.

20. The method of claim 17, wherein the aryl monomer in step a) is represented by the following structural formula: 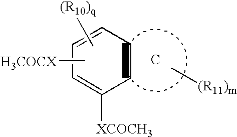
wherein:
Ring C is a five or six membered aromatic or carbocyclic or heterocyclic non-aromatic ring;
each R₁₀ is independently C1-C10 alkyl group, —OH, —SH or —NH₂;
R₁₁ is ═O, —OH, C1-C4 alkyl, optionally substituted aryl, -OC(O)(C1-C4 alkyl), —OC(O)(aryl), —OC(O)(substituted aryl), —OC(O)(aralkyl), or —OC(O)(substituted aralkyl);
q is 0 or 1; and
m is an integer from 0 to 3.

21. The method of claim 20, wherein Ring C is an optionally substituted non-aromatic heterocyclic ring.

22. The method of claim 21, wherein Ring C is an optionally substituted tetrahydropyranyl or dihydropyranyl.

23. The method of claim 22, wherein the aryl monomer in step a) is represented by the following structural formula:

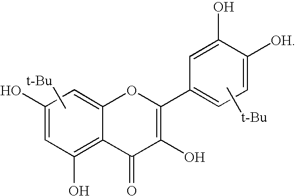

24. The method of claim 22, wherein the aryl monomer in step a) is represented by the following structural formula:

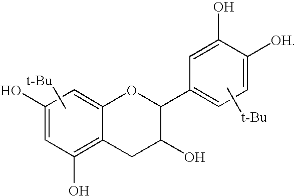

25. The method of claim 22, wherein the aryl monomer in step a) is represented by the following structural formula:

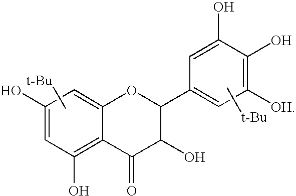

26. The method of claim 22, wherein the aryl monomer in step a) is represented by the following structural formula:

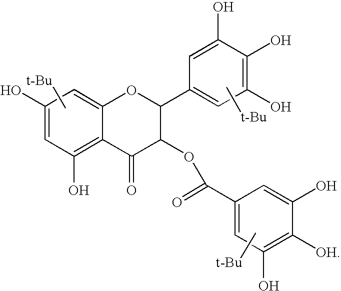

27. A method of synthesizing an antioxidant polymer, comprising the steps of:
a) mono-deprotecting an aryl monomer represented by the following structural formula: 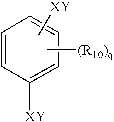
wherein:
at least one ring carbon atom substituted with an XY group is adjacent to a ring carbon atom substituted with an optionally substituted C1-C10 alkyl group or an optionally substituted aryl group;
each X is independently —O—, —NH— or —S—;
each Y is benzyl, benzoyl, tetrahydropyranyl, carbonate, acetal, ketal, tretyl, dimethoxytretyl, trimethoxytretyl or silyl;
each R₁₀ is independently an optionally substituted C1-C 10 alkyl group, an optionally substituted aryl group, and optionally substituted alkoxy group, an optionally substituted carbonyl group, an optionally substituted alkoxycarbonyl group, an optionally substituted aryloxycarbonyl group, —OH, —SH or —NH₂; and/or two R₁₀ groups on adjacent carbon atoms join together to form an optionally substituted aromatic ring or an optionally substituted carbocyclic or heterocyclic non-aromatic ring; and
q is an integer from 1 to 2;
to produce a deprotected aryl monomer represented by the following structural formula: 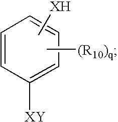
b) polymerizing the deprotected aryl monomer, to form a polymer comprising at least one repeat unit selected from: 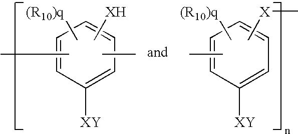
n is an integer greater than or equal to 2;
c) deprotecting the polymer to form an antioxidant polymer comprising at least one repeat unit selected from: [chemical structure]
